(19) United States
(12) Patent Application Publication
(10) Pub. No.: US 2026/0197648 A1
(43) Pub. Date: Jul. 9, 2026

(54) AUTHORIZING SERVICES RELATED TO ARTIFICIAL INTELLIGENCE MACHINE LEARNING ENABLEMENT CLIENT DEVICE MANAGEMENT

(71) Applicant: Lenovo (United States) Inc., Morrisville, NC (US)

(72) Inventors: Sheeba Backia Mary Baskaran, Friedrichsdorf (DE); Andreas Kunz, Ladenburg (DE)

(73) Assignee: Lenovo (United States) Inc., Morrisville, NC (US)

(21) Appl. No.: 19/353,125

(22) Filed: Oct. 8, 2025

(51) Int. Cl. H04W 12/08

(52) U.S. Cl. CPC H04W 12/08

(57) ABSTRACT

Various aspects of the present disclosure relate to authorizing services related to artificial intelligence machine learning enablement (AIMLE) client device management. A service device may transmit a first message requesting an access token including a scope related to an AIMLE client device management service. The service device may receive, responsive to the first message, a second message including the access token, the access token including one or more claims associated with the scope that identify one or more permissions for the AIMLE client device management service.

### TECHNICAL FIELD

The present disclosure relates to wireless communications, and more specifically to authorizing services related to artificial intelligence machine learning enablement (AIMLE) client device management.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The device (e.g., service device or authorization device), processors, and methods of the present disclosure each have several innovative aspects, no single of which is solely responsible for the desirable features disclosed herein.

A service device (e.g., a UE or an NE) for wireless communication is described. The service device may be configured to, capable of, or operable to perform one or more operations as described herein. For example, the service device may be configured to, capable of, or operable to transmit a first message requesting an access token including a scope related to an AIMLE client device management service and receive, responsive to the first message, a second message including the access token, the access token including one or more claims associated with the scope that identify one or more permissions for the AIMLE client device management service.

A processor (e.g., a standalone processor chipset, or a component of the service device) for wireless communication is described. The processor may be configured to, capable of, or operable to perform one or more operations as described herein. For example, the processor may be configured to, capable of, or operable to transmit a first message requesting an access token including a scope related to an AIMLE client device management service and receive, responsive to the first message, a second message including the access token, the access token including one or more claims associated with the scope that identify one or more permissions for the AIMLE client device management service.

A method performed or performable by a service device for wireless communication is described. The method may include transmitting a first message requesting an access token including a scope related to an AIMLE client device management service and receiving, responsive to the first message, a second message including the access token, the access token including one or more claims associated with the scope that identify one or more permissions for the AIMLE client device management service.

In some implementations, responsive to the AIMLE client device management service including a client registration service, the first message includes expected AIMLE client profiles, expected vertical application layer (VAL) services and expected corresponding permission levels, expected AIML services, expected AIML operations, expected client location, expected AIMLE client capabilities, expected ML models, a resource owner identifier (ID), an audience ID, or any combination thereof and the one or more claims include allowed AIMLE client profiles, allowed VAL services and allowed corresponding permission levels, allowed AIML services, allowed AIML operations, allowed client location, allowed AIMLE client capabilities, allowed ML models, the resource owner ID, an issuer ID, the audience ID, an expiration time, or any combination thereof.

In some implementations, the service device, the processor, and the method may further be configured to, capable of, or operable to transmit a third message requesting to register the service device with a server, the third message including the access token and receive, responsive to the third message and based on the access token, a fourth message including an indication of whether the service device is permitted to be registered with the server.

In some implementations, responsive to the AIMLE client device management service including an AIML client discovery service, the first message includes an expected maximum quantity of AIMLE clients, expected AIMLE client discovery criteria, expected VAL services, expected ML model types, expected AIML services, expected AIML operations, expected dataset requirements, expected client location, expected AIMLE client capabilities, a resource owner ID, an audience ID, or any combination thereof and the one or more claims include an allowed maximum quantity of AIMLE clients, allowed AIMLE client discovery criteria, allowed VAL services, allowed ML model types, allowed AIML services, allowed AIML operations, allowed dataset requirements, allowed client location, allowed client capabilities, the resource owner ID, an issuer ID, the audience ID, an expiration time, or any combination thereof.

In some implementations, the service device, the processor, and the method may further be configured to, capable of, or operable to transmit a fifth message to discover client devices that are available to participate in AIML services, the fifth message including the access token and receive, responsive to the fifth message and based on the access token, a sixth message including an indication of whether one or more client devices are available to participate in AIML services.

In some implementations, responsive to the AIMLE client device management service including an AIML client selection service, the first message includes an expected maximum number of AIMLE clients, expected VAL services, expected AIMLE client IDs, expected AIMLE client selection criteria, expected ML model types, expected AIML services, expected AIML operations, expected dataset requirements, expected client location, expected AIMLE client capabilities, expected AIMLE client set IDs, a resource owner ID, an audience ID, or any combination thereof and the one or more claims include an allowed maximum number of AIMLE clients, allowed VAL services, allowed AIMLE client IDs, allowed AIMLE client selection criteria, allowed ML model types, allowed AIML services, allowed AIML operations, allowed dataset requirements, allowed client location, allowed AIMLE client capabilities, allowed AIMLE client set IDs, the resource owner ID, an issuer ID, the audience ID, an expiration time, or any combination thereof.

In some implementations, the service device, the processor, and the method may further be configured to, capable of, or operable to transmit a seventh message to select client devices that are available to participate in AIML services, the seventh message including the access token and receive, responsive to the seventh message and based on the access token, an eighth message verifying selection of one or more client devices to participate in AIML services.

In some implementations, responsive to the AIMLE client device management service including a client participation service, the first message includes expected VAL services, expected AIMLE client set IDs, expected operation, target ML models, expected AIML services, expected AIML operations, expected AIMLE client selection criteria, expected dataset requirements, a resource owner ID, an audience ID, or any combination thereof and the one or more claims include allowed VAL services, allowed AIMLE client set IDs, allowed AIML server IDs, allowed operation, allowed ML models, allowed AIML services, allowed AIML operations, allowed AIMLE client selection criteria, allowed dataset requirements, the resource owner ID, an issuer ID, the audience ID, an expiration time, or any combination thereof.

In some implementations, the service device, the processor, and the method may further be configured to, capable of, or operable to transmit a ninth message requesting a client device to verify participation in AIML services, the ninth message including the access token and receive, responsive to the ninth message and based on the access token, a tenth message including an indication of whether the client device is a participant in AIML services.

In some implementations, responsive to the AIMLE client device management service including a client selection subscription service, the first message includes expected VAL services, expected AIMLE client selection criteria, expected quantity of AIMLE clients for selection, target notification endpoint for selected AIMLE clients, a resource owner ID, an audience ID, or any combination thereof and the one or more claims include allowed VAL services, allowed AIMLE client selection criteria, allowed quantity of AIMLE clients for selection, allowed notification endpoint for selected AIMLE clients, an issuer ID, the resource owner ID, the audience ID, an expiration time, or any combination thereof.

In some implementations, the service device, the processor, and the method may further be configured to, capable of, or operable to transmit an eleventh message requesting to subscribe to monitoring one or more client devices, where the eleventh message includes the access token and receive, in response to the eleventh message and based on the access token, a twelve message including an indication of whether the subscription to monitoring the one or more client devices is successful. In some implementations, the service device includes one of an AIMLE client, an AIMLE server, a VAL client, or a VAL server.

An authorization device (e.g., an NE or a base station) for wireless communication is described. The authorization device may be configured to, capable of, or operable to perform one or more operations as described herein. For example, the authorization device may be configured to, capable of, or operable to receive a first message requesting an access token including a scope related to an AIMLE client device management service, generate the access token including one or more claims associated with the scope that identify one or more permissions for the AIMLE client device management service, and transmit, responsive to the first message, a second message including the access token.

A processor (e.g., a standalone processor chipset, or a component of an authorization device) for wireless communication is described. The processor may be configured to, capable of, or operable to perform one or more operations as described herein. For example, the processor may be configured to, capable of, or operable to receive a first message requesting an access token including a scope related to an AIMLE client device management service, generate the access token including one or more claims associated with the scope that identify one or more permissions for the AIMLE client device management service, and transmit, responsive to the first message, a second message including the access token.

A method performed or performable by an authorization device for wireless communication is described. The method may include receiving a first message requesting an access token including a scope related to an AIMLE client device management service, generating the access token including one or more claims associated with the scope that identify one or more permissions for the AIMLE client device management service, and transmitting, responsive to the first message, a second message including the access token.

In some implementations, responsive to the AIMLE client device management service including a client registration service, the first message includes expected AIMLE client profiles, expected VAL services and expected corresponding permission levels, expected AIML services, expected AIML operations, expected client location, expected AIMLE client capabilities, expected ML models, a resource owner ID, an audience ID, or any combination thereof and the one or more claims include allowed AIMLE client profiles, allowed VAL services and allowed corresponding permission levels, allowed AIML services, allowed AIML operations, allowed client location, allowed AIMLE client capabilities, allowed ML models, the resource owner ID, an issuer ID, the audience ID, an expiration time, or any combination thereof.

In some implementations, responsive to the AIMLE client device management service including an AIML client discovery service, the first message includes an expected maximum quantity of AIMLE clients, expected AIMLE client discovery criteria, expected VAL services, expected ML model types, expected AIML services, expected AIML operations, expected dataset requirements, expected client location, expected AIMLE client capabilities, a resource owner ID, an audience ID, or any combination thereof and the one or more claims include an allowed maximum quantity of AIMLE clients, allowed AIMLE client discovery criteria, allowed VAL services, allowed ML model types, allowed AIML services, allowed AIML operations, allowed dataset requirements, allowed client location, allowed client capabilities, the resource owner ID, an issuer ID, the audience ID, an expiration time, or any combination thereof.

In some implementations, responsive to the AIMLE client device management service including an AIML client selection service, the first message includes an expected maximum number of AIMLE clients, expected VAL services, expected AIMLE client IDs, expected AIMLE client selection criteria, expected ML model types, expected AIML services, expected AIML operations, expected dataset requirements, expected client location, expected AIMLE client capabilities, expected AIMLE client set IDs, a resource owner ID, an audience ID, or any combination thereof and the one or more claims include an allowed maximum number of AIMLE clients, allowed VAL services, allowed AIMLE client IDs, allowed AIMLE client selection criteria, allowed ML model types, allowed AIML services, allowed AIML operations, allowed dataset requirements, allowed client location, allowed AIMLE client capabilities, allowed AIMLE client set IDs, the resource owner ID, an issuer ID, the audience ID, an expiration time, or any combination thereof.

In some implementations, responsive to the AIMLE client device management service including a client participation service, the first message includes expected VAL services, expected AIMLE client set IDs, expected operation, target ML models, expected AIML services, expected AIML operations, expected AIMLE client selection criteria, expected dataset requirements, a resource owner ID, an audience ID, or any combination thereof and the one or more claims include allowed VAL services, allowed AIMLE client set IDs, allowed AIML server IDs, allowed operation, allowed ML models, allowed AIML services, allowed AIML operations, allowed AIMLE client selection criteria, allowed dataset requirements, the resource owner ID, an issuer ID, the audience ID, an expiration time, or any combination thereof.

In some implementations, responsive to the AIMLE client device management service including a client selection subscription service, the first message includes expected VAL services, expected AIMLE client selection criteria, expected quantity of AIMLE clients for selection, target notification endpoint for selected AIMLE clients, a resource owner ID, an audience ID, or any combination thereof and the one or more claims include allowed VAL services, allowed AIMLE client selection criteria, allowed quantity of AIMLE clients for selection, allowed notification endpoint for selected AIMLE clients, an issuer ID, the resource owner ID, the audience ID, an expiration time, or any combination thereof.

### BRIEF DESCRIPTION OF THE DRAWINGS

FIG. 1 illustrates an example of a wireless communications system in accordance with aspects of the present disclosure.

FIGS. 2 through 16 illustrate examples of process flows in accordance with aspects of the present disclosure.

FIG. 17 illustrates an example of a UE in accordance with aspects of the present disclosure.

FIG. 18 illustrates an example of a processor in accordance with aspects of the present disclosure.

FIG. 19 illustrates an example of an NE in accordance with aspects of the present disclosure.

FIG. 20 illustrates an example of a flowchart of a method performed by a service device in accordance with aspects of the present disclosure.

FIG. 21 illustrates an example of a flowchart of a method performed by an authorization device in accordance with aspects of the present disclosure.

### DETAILED DESCRIPTION

A wireless communications system may support AIMLE client device management services, such as AIMLE client registration, AIMLE client discovery, AIMLE client selection, AIMLE client participation, and AIMLE client selection subscription. Prior to initiating one or more of the AIMLE client device management services, a service device (e.g., an AIMLE client, an AIMLE server, a VAL client, and a VAL server) may obtain an access token that the service device may then use to request one of the AIMLE client device management services. The service device may obtain the access token by transmitting a request message to an authorization device. Subsequently, the service device may receive a response message that includes the access token from the authorization device.

However, in some wireless communications systems, authorization scope(s) within the request message may be optional and not well defined which may potentially lead to unauthorized devices performing the AIMLE client device management services. One or more concerns related to unauthorized devices performing the AIMLE client device management services may include data poisoning, data breaches, model theft, compromised accuracy, intellectual property theft, model compromise, disruption of operations, etc.

The techniques described herein provide for fine-granularity authorization to secure AIMLE client device management services. In some examples, a service device may transmit an access token request message requesting an access token with a scope related to an AIMLE client device management service. In response to the access token request message, the service device may receive an access token response message that includes the access token. In some examples, the access token may include one or more claims associated with the scope that identify one or more permissions for the AIMLE client device management service. The service device may then use the access token to request the AIMLE client device management service.

It should be understood that various terms may be used interchangeably with “communicating,” such as “signaling,” “transmitting,” “receiving,” “outputting,” “forwarding,” “relaying,” “retrieving,” “obtaining,” and so forth.

By performing the techniques described, the wireless communications system provides fine-granularity authorization of AIMLE services which may reduce or eliminate unauthorized devices from performing the AIMLE services.

Aspects of the present disclosure are described in the context of a wireless communications system. Additional aspects of the present disclosure are described in the context of component diagrams, process flows, method flows, etc. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

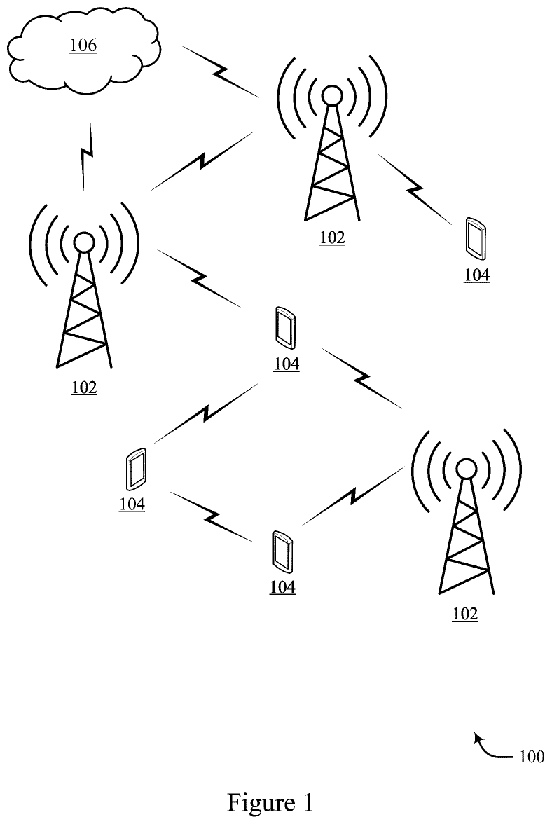

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 may support AIMLE. To support the AIMLE, devices of the wireless communications system 100 may include AIMLE functional entities. For example, the UE 104 may include a VAL client and an AIMLE client. Similarly, the network may include a VAL server and an AIMLE server. The VAL client may communicate with the VAL server over a VAL-UU interface which supports both unicast and multicast delivery modes. Further, the AIMLE client may communicate with the AIMLE server over an AIML-UU interface.

The AIMLE may include a common set of services for comprehensive enablement of AIMLE functionality including federate and distributed learning. Further, the AIMLE may provide AIMLE functionality to the VAL. For example, the AIMLE provides AIMLE functionality to the VAL client over an AIML-C interface, Further, the VAL server may communicate with the AIMLE server via the AIML-S interface. The AIMLE server may also interact with a ML repository over an AIML-R interface. The ML repository may serve as a repository for ML models and ML participants. Further, in some examples, the AIMLE server may be deployed as a service enabler architecture layer (SEAL) server in a SEAL framework.

AIMLE may also support off-network (or UE-to-UE) functionality. For off-network functionality, the VAL client of a first UE 104 may communicate with a VAL client of a second UE 104 over a VAL-PC5 interface which supports unicast and multicast delivery modes. In some examples, the first UE 104 may operate as a relay. That is, the first UE 104 may be connected to the network via a VAL-UU interface and thus enable the second UE 104 to access a VAL server of the network. Further, the AIMLE client of the first UE 104 may communicate with a AIMLE client of the second UE over the AIML-PC5 interface. The AIMLE client may provide functionality to a respective VAL client over the AIML-C interface. Such communication may be performed to support local ML operations (e.g., training, distribution, or interference) in a coordinated manner.

According to implementations, one or more of the NEs 102 and the UEs 104 are operable to implement various aspects of the techniques described with reference to the present disclosure. For example, a service device (e.g., a UE 104 or an NE 102) may transmit a first message requesting an access token comprising a scope related to an AIMLE client device management service and receive, responsive to the first message, a second message comprising the access token, the access token comprising one or more claims associated with the AIMLE client device management service. An authorization device (e.g., an NE 102) may receive a first message requesting an access token including a scope related to an AIMLE client device management service, generate the access token including one or more claims associated with the scope that identify one or more permissions for the AIMLE client device management service, and transmit, responsive to the first message, a second message including the access token.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

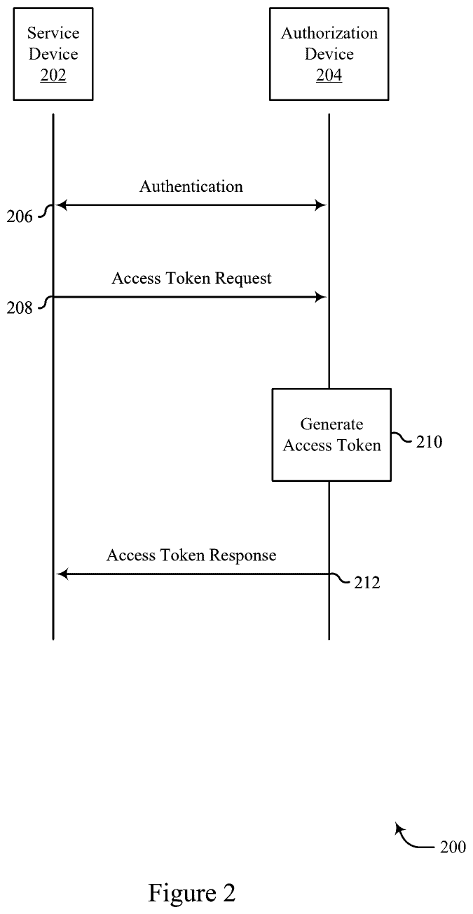

FIG. 2 illustrates an example of a process flow 200 in accordance with aspects of the present disclosure. The process flow 200 may be performed by a service device 202 and an authorization device 204.

At 206, the service device 202 may perform authentication with the authorization device 204. In some examples, the service device 202 may be an example of an AIMLE client, a VAL client, an AIMLE server, or a VAL server. The authorization device 204 may be an example of a SEAL identity management server (SIM-S), an AIMLE server, or a SEAL server.

At 208, the service device 202 may transmit an access token request (or a first message) to the authorization device 204. The access token request may request an access token that includes a scope related an AIMLE service (e.g., AIMLE client registration, AIMLE client registration update, AIMLE client de-registration, AIMLE client discovery, AIMLE client selection, AIMLE client participation, AIMLE client selection subscription update, AIMLE client selection unsubscribe, AIML task transfer assist, AIML task transfer, direct AIML task transfer, transfer learning enablement, AIMLE context transfer, ML model handling, including ML model training capability evaluation, ML model updating, ML model performance monitoring, and ML model selection, AIMLE service operations control and management, etc.).

The access token request may include one or more information elements (IEs). For example, the access token request may include one or more of a scope IE, an audience IE, a cnonce IE, a req_cnf IE, or a resource owner ID IE. The scope IE may be an optional IE or a required IE and may request authorization scopes for the access token. The audience IE may be an optional IE and may request a specific authorization device 204 or resources for the access token. Additionally, the audience IE may request a specific device (e.g., AIMLE server ID, AIMLE service provider ID, AIMLE service producer ID) for AIMLE-related service. The connect IE may be a required IE. The req_cnf IE may be an optional IE and may include information about a key that the service device 202 (or SEAL client) may bind to the access token for proof-of-possession. The resource owner ID IE may include an ID of a resource owner.

In some examples, the service device 202 may modify information or claims included in the scope IE based on the applicable AIMLE service. For example, Table 1 illustrates the information included in the scope IE if the applicable AIMLE service is an AIMLE client registration service, an AIMLE client registration update service, or an AIMLE de-registration service. With reference to Table 1, the expected AIML services may include training, model transfer, model interference, model offload, or model split. The expected client location may include coordinates, a civic address, a network area, or VAL service area ID. The ML model information may include ML model address(es) or analytics ID(s).

TABLE 1
Access Token Request

| Parameter | Value |
|---|---|
| Scope | OPTIONAL. This field requests authorization scope for the access token and |
| | AIMLE service-related information related to AIMLE client management. |
| | Additionally, service device ID (e.g., AIMLE Client ID) as subject, AIMLE client |
| | registration service, AIMLE client registration update service, or AIMLE de- |
| | registration service as scope, expected AIMLE client profiles, list of expected |
| | VAL services (e.g., expected VAL service IDs) and expected corresponding |
| | permission levels, expected AIML services, expected AIML operations, expected |
| | client location for member client selection, expected AIMLE client capabilities, |
| | expected ML model ID list for AIMLE client usage, expected ML model |
| | information for AIMLE client usage, a resource owner ID (e.g., GPSI), an |
| | audience ID (e.g., AIMLE server ID), or an expiration time. |

Table 2 illustrates the information included in the scope I if the applicable AIMLE service is an AIMLE client discovery service. With reference to Table 2, the expected ML model types may include decision trees, linear regression, or neutral networks. The expected AIML services may include training, model transfer, model interference, model offload, or model split. The expected client location may include coordinates, a civic address, a network area, or a VAL service area ID.

TABLE 2
Access Token Request

| Parameter | Value |
|---|---|
| Scope | OPTIONAL. This field requests authorization scope for the access token and |
| | AIMLE service-related information related to AIMLE client management. |
| | Additionally, service device ID (e.g., VAL Server ID) as subject, AIMLE client |
| | discovery service as scope, expected maximum quantity of AIMLE clients, |
| | expected AIMLE client discovery criteria, expected VAL services, expected ML |
| | model types, expected AIML services, expected AIML operations, expected |
| | dataset requirements, expected client location for member client discovery or |
| | selection, expected AIMLE client task capabilities, a resource owner ID (e.g., |
| | GPSI), or an audience ID (e.g., AIMLE Server ID). |

Table 3 illustrates the information included in the scope IE if the applicable AIMLE service is an AIMLE client selection service. With reference to Table 3, the expected AIMLE client selection criteria may include a service permission level usage (e.g., premium resource usage, standard resource usage, or limited resource usage). The expected ML model types may include decision trees, linear regression, or neutral networks. The expected AIML services may include training, model transfer, model interference, model offload, or model split. The expected client location may include coordinates, a civic address, a network area, or VAL service area ID.

TABLE 3
Access Token Request

| Parameter | Value |
|---|---|
| Scope | OPTIONAL. This field requests authorization scope for the access token and |
| | AIMLE service-related information related to AIMLE client management. |
| | Additionally, service device ID (e.g., VAL Server ID) as subject, AIMLE client |
| | selection service as scope, expected maximum quantity of AIMLE clients, list of |
| | expected VAL services (e.g., expected VAL service IDs), expected AIMLE client |
| | IDs, expected AIMLE client selection criteria, expected ML model types, |
| | expected AIML services, expected AIML operations, expected dataset |
| | requirements, expected client location, expected AIMLE client task capabilities, |
| | expected AIMLE client set IDs, a resource owner ID (e.g., GPSI), or an audience |
| | ID (e.g., AIMLE server ID). |

Table 4 illustrates the information included in the scope IE if the applicable AIMLE service is an AIMLE client participation service. With reference to Table 4, the expected operations may include add indicator or remove indicator. The expected AIMLE client selection criteria may include a service permission level usage (e.g., premium resource usage, standard resource usage, or limited resource usage). The expected AIML services may include training, model transfer, model interference, model offload, or model split.

TABLE 4
Access Token Request

| Parameter | Value |
|---|---|
| Scope | OPTIONAL. This field requests authorization scope for the access token and |
| | AIMLE service-related information related to AIMLE client management. |
| | Additionally, service device ID (e.g., AIMLE Server ID) as subject, AIMLE |
| | client participation service as scope, list of expected VAL services (e.g., expected |
| | VAL service IDs), expected AIMLE client set IDs, expected operations, target |
| | AIML model IDs, expected AIML services, expected AIML operations, expected |
| | AIMLE client selection criteria per VAL service ID, expected dataset |
| | requirements, a resource owner ID (e.g., GPSI), or an audience ID (e.g., AIMLE |
| | client ID). |

Table 5 illustrates the information included in the scope I if the applicable AIMLE service is an AIMLE client selection subscription service, an AIMLE client selection subscription update service, and an AIMLE client selection unsubscribe service. With reference to Table 5, the expected AIMLE client selection criteria may include a service permission level usage (e.g., premium resource usage, standard resource usage, or limited resource usage).

TABLE 5
Access Token Request

| Parameter | Value |
|---|---|
| Scope | OPTIONAL. This field requests authorization scope for the access token and |
| | AIMLE service-related information related to AIMLE client management. |
| | Additionally, service device ID (e.g., VAL Server ID) as subject, the AIMLE |
| | client selection subscription service, the AIMLE client selection subscription |
| | update service, or the AIMLE client selection unsubscribe service as scope, list of |
| | expected VAL services (e.g., expected VAL service IDs), expected AIML |
| | services, expected AIMLE client selection criteria per VAL service ID, expected |
| | quantity of AIMLE clients for selection, target notification endpoint for the |
| | selected AIMLE client, a resource owner ID (e.g., GPSI), an audience ID (e.g., |
| | AIMLE server ID), or an expiration time. |

Table 6 illustrates the information included in the scope IE if the applicable AIMLE service is an AIML task transfer service (e.g., an AIML task transfer assist service, an AIML task transfer service, a direct AIML task transfer service, or an AIMLE server-controlled task transfer service). With reference to Table 6, the expected task transfer type/mode may include AIML task transfer assistance, direct AIML task transfer, or AIMLE server-controlled task transfer. The expected AIML task type may include training, model transfer, model interference, model offload, or model split.

TABLE 6
Access Token Request

| Parameter | Value |
|---|---|
| Scope | OPTIONAL. This field requests authorization scope for the access token and |
| | AIMLE service-related information related to AIML task transfer. Additionally, |
| | service device ID as subject, the AIMLE task transfer service as scope, expected |
| | VAL services (e.g., expected VAL service IDs) and expected corresponding |
| | permission levels, expected AIML task transfer type/mode, expected AIMLE task |
| | type, expected ML model ID list, expected time window for task transfer, |
| | expected AIML member IDs or AIMLE client set IDs for task transfer, expected |
| | AIML information type, expected AIML model remaining training or task |
| | transfer requirements, expected time validity, a resource owner ID (e.g., GPSI), |
| | an audience ID, audience set to AIMLE server ID, or audience set to AIMLE |
| | client ID. |

Table 7 illustrates the information included in the scope IE if the applicable AIMLE service is a transfer learning enablement service. With reference to Table 7, the expected transfer learning type/mode may include transfer learning enablement mode or client-triggered transfer learning enablement mode.

TABLE 7
Access Token Request

| Parameter | Value |
|---|---|
| Scope | OPTIONAL. This field requests authorization scope for the access token and |
| | AIMLE service-related information related to transfer learning enablement. |
| | Additionally, service device ID as subject, the transfer learning enablement |
| | service as scope, expected VAL services (e.g., expected VAL service IDs) and |
| | expected corresponding permission levels, expected ML task IDs, expected |
| | transfer learning type/mode, expected ML model profile, expected transfer |
| | learning criteria, expected VAL client IDs, expected ML model requirement |
| | information, expected ML model IDs, expected ML model addresses, expected |
| | ML model ratings, expected ADAE analytics IDs list, expected AIML target |
| | members for transfer learning, a resource owner ID (e.g., GPSI), an audience ID, |
| | audience set as AIMLE server ID, or audience set as ML repository ID. |

Table 8 illustrates the information included in the scope IE if the applicable AIMLE service is a client-triggered transfer learning enablement service. With reference to Table 8, the expected transfer mode may include VAL server triggered or client triggered.

TABLE 8
Access Token Request

| Parameter | Value |
|---|---|
| Scope | OPTIONAL. This field requests authorization scope for the access token and |
| | AIMLE service-related information related to client-triggered transfer learning |
| | enablement. Additionally, service device ID as subject, client-triggered transfer |
| | learning enablement service as scope, expected VAL services (e.g., expected |
| | VAL service IDs) and expected corresponding permission levels, expected ML |
| | task IDs, expected ADAE analytic IDs, expected ML model profile, expected |
| | transfer learning criteria, expected list of VAL client IDs, expected ML model |
| | requirement information, expected list of ML models, expected ML model |
| | addresses, expected ML model rating, expected transfer mode, expected AIML |
| | target members for transfer learning, a resource owner ID (e.g., GPSI), an |
| | audience ID, audience set as AIMLE server ID, audience set as ML repository ID. |

Table 9 illustrates the information included in the scope IE if the applicable AIMLE service is an AIMLE context transfer service. With reference to Table 9, the expected AIML task type may include training, model transfer, model interference, model offload, or model split.

TABLE 9
Access Token Request

| Parameter | Value |
|---|---|
| Scope | OPTIONAL. This field requests authorization scope for the access token and |
| | AIMLE service-related information related to AIMLE context transfer. |
| | Additionally, service device ID as subject, AIMLE context transfer service as |
| | scope, expected service area information related to source edge AIMLE server |
| | IDs, expected list of target edge AIMLE Server ID(s) and service area |
| | information for context transfer, expected list of target AIMLE client IDs for |
| | which context transfer is to done, expected VAL services (e.g., expected VAL |
| | service IDs) and expected corresponding permission levels, expected AIML task |
| | type/mode, expected AIML operation, expected ML Model ID list, ML Model |
| | Information for AIMLE client usage, list of previous managing AIMLE server |
| | IDs, a resource owner ID (e.g., GPSI), an audience ID, audience set to list of |
| | target edge AIMLE server IDs, or an issuer ID. |

Table 10 illustrates the information included in the scope IE if the applicable AIMLE service is ML model training capability evaluation. With reference to Table 10, the expected availability time may indicate a requirement on available time for supporting FL operations. The expected test task information may include tasks for testing ML model training capabilities. The expected AIML model parameters may include information about the AI/ML model and model parameters used for FL training. In VFL, AIML models for different data domains may be included. The expected dataset requirements may include dataset requirements for FL training, including common feature IDS (e.g., IDs of required features common to the dataset of different data domains), data domain feature ID lists (e.g., features for each data domain of the datasets at the UE), and a data source for the FL training.

TABLE 10
Access Token Request

| Parameter | Value |
|---|---|
| Scope | OPTIONAL. This field requests authorization scopes for the access token. This |
| | field requests AIMLE ML model training capability evaluation request/response, |
| | ML model update request/response, delegated ML model information discovery |
| | request/response, ML model performance monitoring subscription |
| | request/response/notification, delegated monitoring AIMLE services and |
| | adaptation of AIMLE services, ML model selection subscription |
| | request/response/notification, delegated ML model selection request/response and |
| | delegated ML model information storage request/response. Additionally expected |
| | availability time for supporting FL operations, expected test task information, |
| | expected AIML model ID and model parameters, expected dataset requirements |
| | (such as common feature ID(s), data domain feature ID(s) list, data source), etc., |
| | expected list of VAL service (IDs) and corresponding permission level(s), |
| | expected AIML Task type or operations/services (such as VFL/HFL), or expected |
| | AIMLE client(s) with resource owner ID as GPSI. |

Table 11 illustrates the information included in the scope IE if the applicable AIMLE service is ML model updating and/or delegated ML model information discovery. With reference to Table 11, the expected model ID may include ID(s) of ML model(s) for which performance degradation has been detected. The expected performance degradation information may include details about detected performance degradation, including time, instances, or other metrics (e.g., accuracy, recall, F1score). The expected ML model retrieval endpoint may include an endpoint (e.g., URL, URI, IP address) where ML model files may be retrieved.

TABLE 11
Access Token Request

| Parameter | Value |
|---|---|
| Scope | OPTIONAL. This field requests authorization scopes for the access token. This |
| | field requests AIMLE ML model training capability evaluation request/response, |
| | ML model update request/response, delegated ML model information discovery |
| | request/response, ML model performance monitoring subscription |
| | request/response/notification, delegated monitoring AIMLE services and |
| | adaptation of AIMLE services, ML model selection subscription |
| | request/response/notification, delegated ML model selection request/response and |
| | delegated ML model information storage request/response. Additionally, |
| | expected ML model ID(s), expected performance degradation information, |
| | expected ML model retrieval endpoint (such as URL, URI, IP address), expected |
| | delegated ML model information discovery service via AIMLE server ID(s) list, |
| | or target resource owner ID(s) as GPSI(s). |

Table 12 illustrates the information included in the scope IE if the applicable AIMLE service is ML model performance monitoring and/or delegated monitoring AIMLE services and delegated adaptation of AIMLE services. With reference to Table 12, the expected ML model ID may include IDs of ML models for which the performance monitoring may apply. The expected notification endpoint may include an endpoint (e.g., URL, URI, IP address) where notifications may be sent. The expected AIML operation information may indicate operations (e.g., ML model training, HFL, VFL, TL) for which an ML model is used, further including a VAL service ID (e.g., IDs of the AIMLE service using the ML model, if known by the requestor), AIMLE client IDs (e.g., IDs of AIMLE clients training the ML model, if known by the requestor), and AIMLE service KPIs (e.g., one or more KPIs for the AIMLE service performance, such as latency, accuracy, etc.). The expected monitoring report configuration for the monitoring service may include thresholds for triggering a monitoring event (e.g., minimum accuracy, delay, whether the reporting is one time, periodical, or event triggered). The expected area of interest (e.g., geographical or service area for which the monitoring applies), time validity (e.g., for the monitoring subscription), and trigger action requirement (e.g., identifies policies for triggering an action based on a monitoring event, such as if degradation is detected, to train a new model or re-select AIMLE clients) may also be included.

TABLE 12
Access Token Request

| Parameter | Value |
|---|---|
| Scope | OPTIONAL. This field requests authorization scopes for the access token. This |
| | field requests AIMLE ML model training capability evaluation request/response, |
| | ML model update request/response, delegated ML model information discovery |
| | request/response, ML model performance monitoring subscription |
| | request/response/notification, delegated monitoring AIMLE services and |
| | adaptation of AIMLE services, ML model selection subscription |
| | request/response/notification, delegated ML model selection request/response and |
| | delegated ML model information storage request/response. Additionally, |
| | expected ML model ID, expected notification endpoint (such as URL, URI, IP |
| | address), expected AIML operation information (such as ML model training, |
| | VFL, HFL, transfer learning etc.), expected list of VAL service ID(s), expected |
| | list of AIMLE client ID(s), expected AIMLE service key performance indicators |
| | (KPIs), expected monitoring report configuration, expected area of interest, |
| | expected validity time period, expected trigger actions, or expected target |
| | resource owner ID(s) as GPSI(s). |

Table 13 illustrates the information included in the scope IE if the applicable AIMLE service is ML model selection and/or delegated ML model selection and delegated ML model information storage. With reference to Table 13, the expected AIML profile may include requirements for the ML model selection, including expected candidate ML models (e.g., a list of ML model IDs and initial model parameters to train and evaluate against a provided dataset), expected ML model requirements (e.g., for use in selecting additional candidate ML models for training with provided datasets), expected AIMLE client set IDs (e.g., for training the ML model), expected AIMLE client selection criteria (e.g., for finding suitable AIMLE clients for training the ML model), an expected number of required AIMLE clients (e.g., a minimum number of AIMLE clients required for training the ML model), expected dataset IDs (e.g., to use for training and evaluating model performance to obtain a list of ML model rankings), and expected training requirements. In addition, a notification target (e.g., endpoint information for receiving notifications) and notification settings (e.g., for which the AIMLE server provides ML model status) may be included.

TABLE 13
Access Token Request

| Parameter | Value |
|---|---|
| Scope | OPTIONAL. This field requests authorization scopes for the access token. This |
| | field requests AIMLE ML model training capability evaluation request/response, |
| | ML model update request/response, delegated ML model information discovery |
| | request/response, ML model performance monitoring subscription |
| | request/response/notification, delegated monitoring AIMLE services and |
| | adaptation of AIMLE services, ML model selection subscription |
| | request/response/notification, delegated ML model selection request/response and |
| | delegated ML model information storage request/response. Additionally, |
| | expected AIML profile (such as list of expected ML model ID(s), ML model |
| | requirements, expected AIMLE client set ID(s), expected AIMLE client selection |
| | criteria, expected number of AIMLE clients, expected data set ID(s), expected |
| | training requirements, expected notification target endpoint (such as URL, URI, |
| | IP address), expected notification settings etc.,), expected delegated list of |
| | AIMLE server IDs (to perform candidate ML model selection service, expected |
| | ML model information storage service etc., for the AIMLE service consumers), |
| | expected list of VAL service ID, or target resource owner ID(s) as GPSI(s). |

Table 14 illustrates the information included in the scope IE if the applicable AIMLE service is AIMLE service operations control and management and/or delegated AIMLE enablement client services operations. With reference to Table 14, the AIMLE service operations control and management selection criteria may include expected VAL service IDs, expected AIMLE client IDs, expected AIMLE client set IDs, expected AIML service operation IDs, expected AIML service operation information, expected AIML service operation modes, expected AIML service operation mode configurations, and expected AIML service operation mode status reporting.

TABLE 14
Access Token Request

| Parameter | Value |
|---|---|
| Scope | OPTIONAL. This field requests authorization scopes for the access token. This |
| | field requests AIMLE service operations control and management service |
| | (request/response), delegated AIML Enablement client service operations |
| | (Request/Response). Additionally, expected target AIMLE client identifiers, |
| | expected target AIMLE client set identifiers, expected AIML service operation |
| | identifiers (such as model training ID, ML task ID, etc.), expected AIML service |
| | operation information, expected AIML service operation mode (such as start, |
| | stop), expected AIML service operation mode configuration, expected AIML |
| | service operation mode status reporting (such as periodic/event based), expected |
| | list of allowed VAL service (IDs) and corresponding permission level(s), |
| | expected AIML task type or operations/services (such as VFL/HFL), or expected |
| | target resource owner ID as GPSI. |

At 210, the authorization device 204 may generate the access token in response to the access token request. In some examples, the authorization device 204 may generate the access token only if the access token request is valid and authorized by the authorization device 204. If the access token request is not valid and authorized, the authorization device 204 will return an error to the service device 202. In some examples, after generating the access token, the authorization device 204 may sign the access token with a public key. Signing the access token may ensure that information included in the access token is not altered during communication. Further, any device receiving the access token (e.g., an audience or verifier) may verify the issuer of the signed access token using the public key.

In some examples, the authorization device 204 may generate the access token based on the information included in the access token request. That is, the information included in the access token may differ depending on the information included in the scope IL of the access token request.

Table 15 illustrates the access token generated in response to the access token request related to the AIMLE client registration service, the AIMLE client registration update service, or the AIMLE de-registration service.

TABLE 15

| Parameter | Value |
|---|---|
| Access | REQUIRED. This is the issued access token. The access token can include claims |
| Token | such as service device ID (e.g., AIMLE client ID) as subject, AIMLE client |
| | registration service, AIMLE client registration update service, or AIMLE de- |
| | registration service as scope, allowed client profiles, list of allowed VAL services |
| | (e.g., allowed VAL service IDs) and allowed corresponding permission levels, |
| | allowed AIML services, allowed AIML operations, allowed client location for |
| | member client selection, allowed AIMLE client capabilities, allowed ML model |
| | ID list for AIMLE client usage, allowed ML model information for AIMLE client |
| | usage, the resource owner ID (e.g., GPSI), an issuer ID (e.g., SEAL server ID or |
| | SIM-S server ID), the audience ID (e.g., AIMLE server ID), or an expiration time. |

Table 16 may illustrate the access token generated in response to the access token request related to the AIMLE client discovery service.

TABLE 16

| Parameter | Value |
|---|---|
| Access | REQUIRED. This is the issued access token. The access token can include claims |
| Token | such as service device ID (e.g., VAL server ID) as subject, AIMLE client |
| | discovery service as scope, allowed maximum quantity of AIMLE clients, |
| | allowed AIMLE client discovery criteria, allowed VAL services, allowed ML |
| | model types, allowed AIML services, allowed AIML operations, allowed dataset |
| | requirements, allowed client location for member client discovery or selection, |
| | allowed AIMLE client task capabilities, the resource owner ID (e.g., GPSI), an |
| | issuer ID (e.g., SEAL server ID or SIM-S server ID), the audience ID (e.g., |
| | AIMLE Server ID), or an expiration time. |

Table 17 may illustrate the access token generated in response to the access token request related to the AIMLE client selection service.

TABLE 17

| Parameter | Value |
|---|---|
| Access | REQUIRED. This is the issued access token. The access token can include claims |
| Token | such as service device ID (e.g., VAL server ID) as subject, AIMLE client |
| | selection service as scope, allowed maximum quantity of AIMLE clients, list of |
| | allowed VAL services (e.g., allowed VAL service IDs), allowed AIMLE client |
| | IDs, allowed AIMLE client selection criteria, allowed ML model types, allowed |
| | AIML services, allowed AIML operations, allowed dataset requirements, allowed |
| | client location, allowed AIMLE client task capabilities, allowed AIMLE client set |
| | IDs, a resource owner ID (e.g., GPSI), an issuer ID (e.g., SEAL server ID or |
| | SIM-S server ID), audience ID (e.g., AIMLE server ID), or an expiration time. |

Table 18 may illustrate the access token generated in response to the access token request related to the AIMLE client participation service.

TABLE 18

| Parameter | Value |
|---|---|
| Access | REQUIRED. This is the issued access token. The access token can include claims |
| Token | such as service device ID (e.g., AIMLE server ID) as subject, AIMLE client |
| | participation service as scope, list of allowed VAL services (e.g., allowed VAL |
| | service IDs), allowed AIMLE client set IDs, allowed AIMLE server IDs, allowed |
| | operations, allowed AIML model IDs, allowed AIML services, allowed AIML |
| | operations, allowed AIMLE client selection criteria per VAL service ID, allowed |
| | dataset requirements, the resource owner ID (e.g., GPSI), the audience ID (e.g., |
| | AIMLE client ID), an issuer ID (e.g., SEAL server ID or SIM-S server ID), or an |
| | expiration time. |

Table 19 may illustrate the access token generated in response to the access token request related to the AIMLE client selection subscription service, the AIMLE client selection subscription update service, or the AIMLE client selection unsubscribe service.

TABLE 19

| Parameter | Value |
|---|---|
| Access | REQUIRED. This is the issued access token. The access token can include claims |
| Token | such as service device ID (e.g., VAL server ID) as subject, the AIMLE client |
| | selection subscription service, the AIMLE client selection subscription update |
| | service, or the AIMLE client selection unsubscribe service as scope, list of |
| | allowed VAL services (e.g., allowed VAL service IDs), allowed AIMLE client |
| | selection criteria per VAL service ID, allowed quantity of AIMLE clients for |
| | selection, allowed notification endpoint for the selected AIMLE client, the |
| | resource owner ID (e.g., GPSI), the audience ID (e.g., AIMLE server ID), an |
| | issuer ID (e.g., SEAL server ID or SIM-S server ID), or the expiration time. |

Table 20 may illustrate the access token generated in response to the access token request related to the AIML task transfer service (e.g., an AIML task transfer assist service, an AIML task transfer service, a direct AIML task transfer service, or an AIMLE server-controlled task transfer service).

TABLE 20

| Parameter | Value |
|---|---|
| Access | REQUIRED. This is the issued access token. The access token can include claims |
| Token | such as service device ID (e.g., Source AIML member ID, AIMLE client ID, or |
| | VAL client ID) as subject, AIMLE task transfer assist service as scope, allowed |
| | VAL services (e.g., allowed VAL service IDs) and allowed corresponding |
| | permission levels, allowed AIML task type, allowed ML model ID list, allowed |
| | transfer mode, allowed time window for task transfer, allowed AIML target |
| | members for task transfer, resource owner ID (e.g., GPSI), audience ID (e.g., |
| | AIMLE server and/or ML repository ID), or issuer ID (e.g., SIM-S ID). |
| | REQUIRED. This is the issued access token. The access token can include claims |
| | such as service device ID (e.g., AIMLE server ID) as subject, the AIML task |
| | transfer as scope, allowed list of source AIML member IDs, allowed list of target |
| | member IDs, allowed VAL services (e.g., allowed VAL service IDs) and allowed |
| | corresponding permission levels, allowed AIML task type, allowed ML model ID |
| | list, allowed transfer mode, allowed time window for task transfer, allowed AIML |
| | target members for task transfer, resource owner ID (e.g., GPSI), audience ID |
| | (e.g., list of allowed target AIMLE client IDs and/or ML repository ID), or issuer |
| | ID (e.g., SIM-S ID). |
| | REQUIRED. This is the issued access token. The access token can include claims |
| | such as service device ID (e.g., AIMLE client ID or source AIMLE member ID) |
| | as subject, the direct AIML task transfer service as scope, allowed VAL services |
| | (e.g., allowed VAL service IDs) and allowed corresponding permission levels, |
| | allowed AIML task type, allowed ML model ID list, allowed transfer mode, |
| | allowed time window for task transfer, allowed AIML target members for task |
| | transfer, resource owner ID (e.g., GPSI), audience ID (e.g., list of allowed target |
| | AIMLE client IDs and/or ML repository ID), or issuer ID (e.g., SIM-S ID). |
| | REQUIRED. This is the issued access token. The access token can include claims |
| | such as service device ID (e.g., source AIMLE member ID, AIMLE client ID, or |
| | VAL client ID) as subject, the AIMLE server-controlled AIML task transfer |
| | service as scope, allowed VAL services (e.g., allowed VAL service IDs) and |
| | allowed corresponding permission levels, allowed AIML task type, allowed ML |
| | model ID list, allowed transfer mode, allowed time window for task transfer, |
| | allowed AIML target members for task transfer, resource owner ID (e.g., GPSI), |
| | audience ID (e.g., AIMLE server ID and/or ML repository ID), or issuer ID (e.g., |
| | SIM-S ID). |

Table 21 may illustrate the access token generated in response to the access token request related to the transfer learning enablement service.

TABLE 21

| Parameter | Value |
|---|---|
| Access | REQUIRED. This is the issued access token. The access token can include claims |
| Token | such as service device ID (e.g., VAL server ID) as subject, the transfer learning |
| | enablement service as scope, allowed VAL services (e.g., allowed VAL service |
| | IDs) and allowed corresponding permission levels, allowed ML task IDs, allowed |
| | ADAE analytics IDs list, allowed ML profile, allowed transfer learning criteria, |
| | allowed list of VAL clients IDs, allowed ML model requirement information, |
| | allowed list of ML model IDs, allowed transfer type/mode, allowed AIML target |
| | members for transfer learning, allowed transfer learning type/mode, resource |
| | owner ID (e.g., GPSI), an audience ID (e.g., AIMLE server ID and/or ML |
| | repository ID), or issuer ID (e.g., SIM-S ID). |

Table 22 may illustrate the access token generated in response to the access token request related to the client-triggered transfer learning enablement service.

TABLE 22

| Parameter | Value |
|---|---|
| Access | REQUIRED. This is the issued access token. The access token can include claims |
| Token | such as service device ID (e.g., VAL client ID) as subject, client-triggered |
| | transfer learning enablement service as scope, allowed VAL services (e.g., |
| | allowed VAL service IDs) and allowed corresponding permission levels, allowed |
| | ML task IDs, allowed ADAE analytic IDs, allowed ML model profile, allowed |
| | transfer learning criteria, allowed list of VAL client IDs, allowed ML model |
| | requirement information, allowed list of ML models, allowed ML model |
| | addresses, allowed ML model rating, allowed transfer mode, allowed AIML |
| | target members for transfer learning, resource owner ID (e.g., GPSI), audience ID |
| | (e.g., AIMLE server ID and/or ML repository ID), or issuer ID (e.g., SIM-S ID). |

Table 23 may illustrate the access token generated in response to the access token request related to the AIMLE context transfer service.

TABLE 23

| Parameter | Value |
|---|---|
| Access | REQUIRED. This is the issued access token. The access token can include claims |
| Token | such as service device ID (e.g., source edge AIMLE server ID) as subject, |
| | AIMLE context transfer service as scope, allowed service area information |
| | related to source edge AIMLE server IDs, allowed list of target edge AIMLE |
| | Server ID(s) and service area information for context transfer, allowed list of |
| | target AIMLE client IDs for which context transfer is to done, allowed VAL |
| | services (e.g., allowed VAL service IDs) and allowed corresponding permission |
| | levels, allowed AIML task type/mode, allowed AIMLE operations, allowed ML |
| | Model ID list, allowed ML Model Information for AIMLE client usage, list of |
| | previous managing AIMLE server IDs, resource owner ID (e.g., GPSI), audience |
| | ID (e.g., list of allowed target edge server IDs and/or ML repository ID), or issuer |
| | ID (e.g., SIM-S ID). |

Table 24 may illustrate the access token generated in response to the access token request related to ML model training capability evaluation.

TABLE 24

| Parameter | Value |
|---|---|
| Access | REQUIRED. The access token includes the claims such as requestor ID/AIMLE |
| Token | server ID as subject, ML model training capability evaluation services |
| | (request/response), ML model update request/response, delegated ML model |
| | information discovery request/response, ML model performance monitoring |
| | subscription request/response/notification, delegated monitoring AIMLE services |
| | and adaptation of AIMLE services, ML model selection subscription |
| | request/response/notification, delegated ML model selection request/response and |
| | delegated ML model information storage request/response as scope, allowed |
| | availability time for supporting FL operations, allowed test task information, |
| | allowed AI/ML model ID and model parameters, allowed dataset requirements |
| | (such as common feature ID(s), data domain feature ID(s) list, data source), etc., |
| | list of allowed VAL service (IDs) and allowed corresponding permission level(s), |
| | allowed AIML task type or operations/services (such as VFL/HFL), or resource |
| | owner ID as GPSI. Audience as AIMLE client ID/VAL client ID, and issuer as SIM-S. |

Table 25 may illustrate the access token generated in response to the access token request related to ML model updating and/or delegated ML model information discovery.

TABLE 25

| Parameter | Value |
|---|---|
| Access | REQUIRED. Access token response message, the authorization information or |
| Token | access token (which includes claims such as requestor ID/AIMLE consumer ID |
| | as subject, ML model update service (request/response), ML model information |
| | discovery (request/response) as scope. Allowed ML model ID, allowed |
| | performance degradation information, allowed ML model retrieval endpoint |
| | (such as URL, URI, IP address), delegated ML model information discovery |
| | service via AIMLE server ID(s) list, or resource owner ID as GPSI. Audience as |
| | AIMLE server IDs, ML repository IDs, and issuer as SIM-S). |

Table 26 may illustrate the access token generated in response to the access token request related to ML model performance monitoring and/or delegated monitoring AIMLE services and delegated adaptation of AIMLE services.

TABLE 26

| Parameter | Value |
|---|---|
| Access | REQUIRED. Access token response message, the authorization information or |
| Token | access token (which includes claims such as requestor ID such as VAL server ID |
| | as subject, ML model performance monitoring subscription service |
| | (request/response/notify) as scope. Allowed ML model ID, allowed notification |
| | endpoint (such as URL, URI, IP address), allowed AIML operation information |
| | (such as ML model training, VFL, HFL, transfer learning etc.), list of VAL |
| | service ID(s), list of AIMLE client ID(s), AIMLE service KPIs, allowed |
| | monitoring report configuration, allowed area of interest, allowed validity time |
| | period, allowed trigger actions, or resource owner IDs as GPSI. Audience as |
| | AIMLE server IDs, AIMLE client ID(s), and issuer as SIM-S). |

Table 27 may illustrate the access token generated in response to the access token request related to ML model selection and/or delegated ML model selection and delegated ML model information storage.

TABLE 27

| Parameter | Value |
|---|---|
| Access | REQUIRED. Access token response message, the authorization information or |
| Token | access token (which includes claims such as requestor ID such as AIMLE Service |
| | consumer ID as subject, ML model selection subscription service |
| | (request/response/notify), candidate ML model selection service, ML model |
| | information storage service as scope, allowed AIML profile (such as list of |
| | allowed ML model ID(s), ML model requirements, allowed AIMLE client set |
| | ID(s), allowed AIMLE client selection criteria, allowed number of AIMLE |
| | clients, allowed data set ID(s), allowed training requirements, allowed |
| | notification target endpoint (such as URL, URI, IP address), allowed notification |
| | settings etc.,), delegated list of AIMLE server IDs (to perform candidate ML |
| | model selection service, ML model information storage service etc., for the |
| | AIMLE service consumers), list of VAL service ID, or resource owner ID as |
| | GPSI. Audience as AIMLE Server IDs, ML Repository ID(s), and Issuer as SIM-S). |

Table 28 may illustrate the access token generated in response to the access token request related to AIMLE service operation control management and/or delegated AIMLE enablement clients service operations.

TABLE 28

| Parameter | Value |
|---|---|
| Access | REQUIRED. Access token response message, the authorization information or |
| Token | access token (which includes claims such as VAL server ID as subject, AIMLE |
| | service operations control and management service (request/response), AIML |
| | enablement client service operations (request/response) as scope, allowed target |
| | AIMLE client identifiers, allowed target AIMLE client set identifiers, allowed |
| | AIML service operation identifiers (such as model training ID, ML task ID, etc.), |
| | allowed AIML service operation information, allowed AIML service operation |
| | mode (such as start, stop), allowed AIML service operation mode configuration, |
| | allowed AIML service operation mode status reporting (such as periodic/event |
| | based), list of allowed VAL service (IDs) and allowed corresponding permission |
| | level(s), allowed AIML task type or operations/services (such as VFL/HFL), or |
| | resource owner ID as GPSI. Audience as AIMLE server IDs, AIMLE client |
| | ID/VAL client ID(s), and issuer as SIM-S). |

At 212, the authorization device 204 may transmit an access token response (or a second message) to the service device 202. The access token response may include one or more JEs. For example, the access token response may include one or more of an access token IE, an expire_in IE, a refresh_token IL, an ace_profile IL, a cnf IL, and an rs_cnf IL. The access token IL may be a required IL and may include the information presented in Tables 15-28. The expires_in IL may be a required IL and may include an indication of a lifetime of the access token in seconds. The refresh_token IL may be an optional IL and may include an issued refresh token. The ace_profile may be a required IL and may indicate an authentication and authorization for constrained environment (ACE) profile that the service device 202 (or SEAL client) may use towards the SEAL server or resource. The cnf IE may be an optional JE. The rs_cnf may be an optional JE.

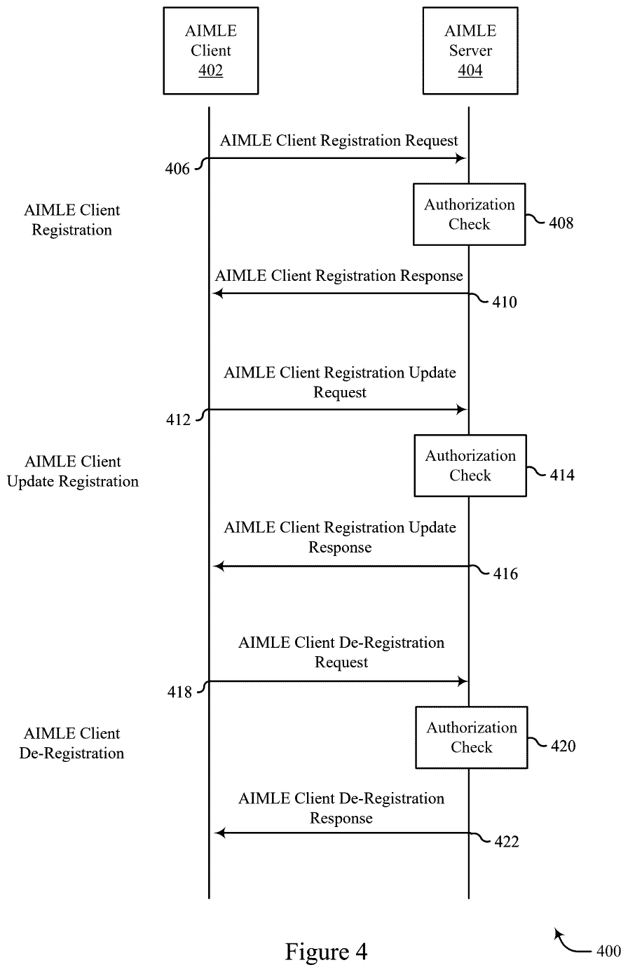

The service device 202 may now use the access token to make protected and authorized requests to a service producer (e.g., the AIMLE server, the VAL server, the AIMLE client, etc.). FIGS. 4-16 describe how the service device 202 may utilize the access token for different AIMLE services. Additionally, the various AIMLE security procedures described with reference to FIGS. 2 and 4-16 may also be applicable to a common application programming interface (API) framework (CAPIF). In such a CAPIF framework, an AIMLE client or a VAL UE may take a role of an API invoker residing as part of a UE, a VAL server may take a role of an API invoker residing as part of an application function (AF) or an application server, a SIM-S or an authorization server may take a role of a CAPIF, an AIMLE server may take a role of an API exposure function (AEF), and an ML repository may take a role of any function in the CAPIF framework.

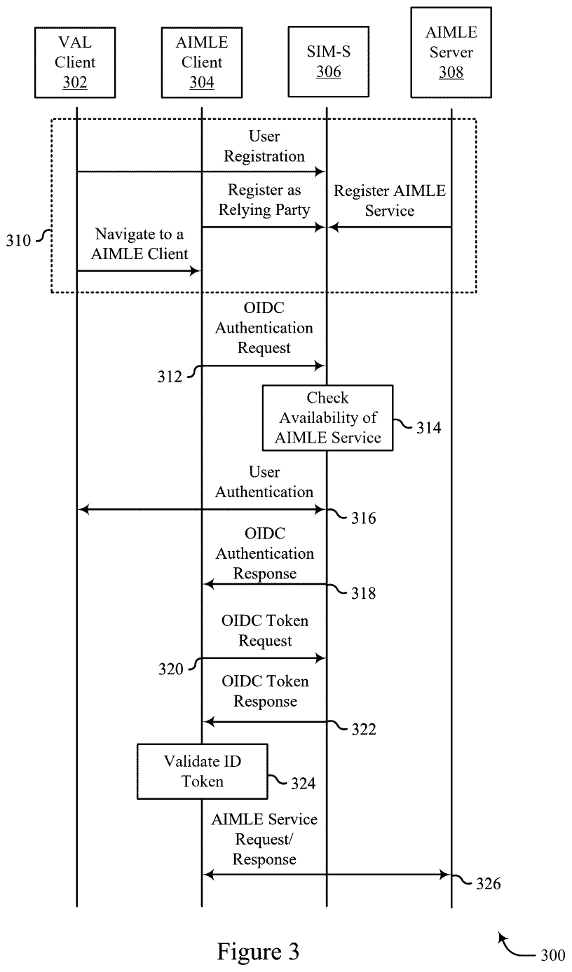

FIG. 3 illustrates an example of a process flow 300 in accordance with aspects of the present disclosure. The process flow 300 may be performed by a VAL client 302, an AIMLE client 304, a SIM-S 306, and an AIMLE server 308.

Steps 310-326 may describe an alternative method in which a service device (e.g., the AIMLE client 304) may obtain an access token for AIMLE services.

At 310, the AIMLE client 304 may register to the SIM-S 306 as a relying party and delegate identity management and user authentication to the SIM-S 306 which may take the role of OpenID provider. Further, AIMLE service may be registered to the SIM-S 306. The VAL client 302 may also register to the SIM-S 306 with a user profile and get User ID from the SIM-S 306. The VAL client 302 may navigate to the AIMLE client 304 with the User ID.

At 312, the AIMLE client 304 may transmit an OpenID connect (OIDC) authentication request to the SIM-S 306. The OIDC authentication request may include the User ID, GSPI, and response type. The scope of the OIDC authentication request may be set to OpenID and an AIMLE service.

At 314, The SIM-S 306 may check if the AIMLE service is available. In addition, the SIM-S 306 may check if the AIMLE client 304 is allowed to access the AIMLE service according to local policy.

At 316, the SIM-S may trigger user authentication towards the VAL client 302 and obtain authorization from the VAL client 302 to allow the AIMLE client 304 to access the AIMLE service.

At 318, the SIM-S 306 may transmit an OIDC response to the AIMLE client 304 with an authentication code.

At 320, the AIMLE client 304 may transmit a token request to the SIM-S 306 with the authentication code. In some examples, the token request may include expected AIMLE service related information. For example, the token request may scope information which may include any of the expected service-related information presented in Tables 1-14.

At 322, the SIM-S 306 may transmit a token response to the AIMLE client 304. The token response may include an ID token and an access token. The ID token may include an issuer ID set to the SIM-S 306, an audience ID set to AIMLE client 304, a subject ID set to User ID, a resource owner ID set to GPSI, and an expiration time. The access token may include an issuer ID set to the SIM-S 306, an audience ID set to the AIMLE server 308, a subject set to the User ID or VAL client ID, a resource owner ID set to GSPI, scope set to an AIMLE service, allowed service-related information, and an expiration time. The allowed service-related information may be any of the information presented in Tables 15-28. In some examples, the expiration time in the access token may be shorter than the one in the ID token.

At 324, the AIMLE client 304 may validate the ID token to authenticate the VAL client 302. Prior to any associated AIMLE service requests, secure connection may be established between the AIMLE client 304 and the AIMLE server 308.

At 326, the AIMLE client 304 may transmit an AIMLE service request to the AIMLE server 308 that includes the access token obtained at 322.

Upon receiving the AIMLE service request with the access token, the AIMLE server 308 may verify the access token and retrieve User ID or GPSI from the subject claim of the access token. The AIMLE server 308 may further check if the User ID or GPSI matches one of the owners or one of the uses or users in an AIMLE client profile of the allowed or accessed AIMLE service or resource. If yes, the AIMLE server 308 may further check if the requested operation is allowed by this user based on access control list of the AIMLE client profile of the allowed AIMLE service or resource. If yes, the AIMLE server 308 may perform the requested AIMLE service. Otherwise, AIMLE server 308 may reject the AIMLE service request. In some examples, access token verification includes verifying a digital signature of the access token, checking if the issuer is the SIM-S 306, audience is the AIMLE server 308, client ID matches the AIMLE client 304, scope is the requested AIMLE service, and the access token is not expired.

FIG. 4 illustrates an example of a process flow 400 in accordance with aspects of the present disclosure. The process flow 400 may be performed by an AIMLE client 402 and an AIMLE server 404.

Steps 406 through 410 may relate to an AIMLE client registration service. The AIMLE client registration service may allow the AIMLE client 402 to register with the AIMLE server 404. In some examples, prior to 406, the AIMLE client 402 may be preconfigured or may discover an address of the AIMLE server 404. Further, prior to 406, the AIMLE client may be preconfigured with an AIMLE client profile along with resource owner information such as GPSI. Additionally, prior to 406, the AIMLE client 402 may receive an access token from an authorization server as described in FIG. 2. The access token may include some or all of the information presented in Table 15.

At 406, the AIMLE client 402 may transmit an AIMLE client registration request (or a third message) to the AIMLE server 404. The AIMLE client registration request may include security credentials (e.g., client certificates and/or root certificate to validate the client certificate) and the access token. Other information included in the AIMLE client registration request may include requester ID, list of supported profiles, AIMLE client profile, list of supported services, VAL service ID, service permission level, etc. In some examples, the AIMLE client registration request may also include an indication of the AIMLE client 402 AIML capabilities (e.g., supported ML model types, supported AIML operations, or supported AIMLE client task capabilities).

At 408, The AIMLE server 404 may validate the AIMLE client registration request and perform an authentication and authorization check based on the received security credentials and access token to determine if the AIMLE client 402 is permitted to register to the AIMLE server 404 and participate in AIML services. Upon successful authorization, the AIMLE server 404 may save context of the AIMLE client registration in a ML repository.

At 410, the AIMLE server 404 may transmit an AIMLE client registration response (or a fourth message) to the AIMLE client 402 based on the information included in the access token with the status of the request.

Steps 412 through 416 may relate to an AIMLE client registration update service. The AIMLE client registration update service may allow the AIMLE client 402 to update registration with the AIMLE server 404. In some examples, prior to 412, the AIMLE client 402 may register with the AIMLE server 404. Additionally, prior to 412, the AIMLE client 402 may receive an access token from an authorization server as described in FIG. 2. The access token may include some or all of the information presented in Table 15.

At 412, the AIMLE client 402 may transmit an AIMLE client registration update request to the AIMLE server 404. The AIMLE client registration update request may include a registration ID, an updated list of supported services, an updated AIMLE client profile, security credentials (e.g., client certificates and/or root certificate to validate the client certificate), and the access token. Other information included in the AIMLE client registration request may include VAL service ID, service permission level, etc. In some examples, the AIMLE client 402 may remove services from the list of services identified by service ID(s) when it ceases to provide a service and adds to the service when it starts to provide a service.

At 414, the AIMLE server 404 may validate the AIMLE client registration update request and perform an authentication and authorization check. In other words, the AIMLE server 404 verifies the received security credentials and access token. Upon successful authorization, the AIMLE server 404 may update the context of the AIMLE client registration in the ML repository.

At 416, the AIMLE server 404 may transmit an AIMLE client registration update response to the AIMLE client 402 with the status of the update.

Steps 418 through 422 may relate to an AIMLE client de-registration service. The AIMLE client registration update service may allow the AIMLE client 402 to de-register with the AIMLE server 404. In some examples, prior to 418, the AIMLE client 402 may have already registered with the AIMLE server 404. Additionally, prior to 418, the AIMLE client 402 may receive an access token from an authorization server as described in FIG. 2. The access token may include some or all of the information presented in Table 15.

At 418, the AIMLE client 402 may transmit an AIMLE client de-registration request to the AIMLE server 404. The AIMLE client de-registration request may include a registration ID, security credentials (e.g., client certificates and/or root certificate to validate the client certificate), and the access token.

At 420, the AIMLE server 404 may validate the AIMLE client de-registration request and perform an authentication and authorization check to determine whether the AIMLE client may de-register from AIML services. In other words, the AIMLE server 404 may verify the received security credentials and access token. Upon successful authorization, the AIMLE server 404 may remove context of the AIMLE client registration from the ML repository.

At 422, The AIMLE server 404 transmits an AIMLE client de-registration response to the AIMLE client 402 with the status of the request.

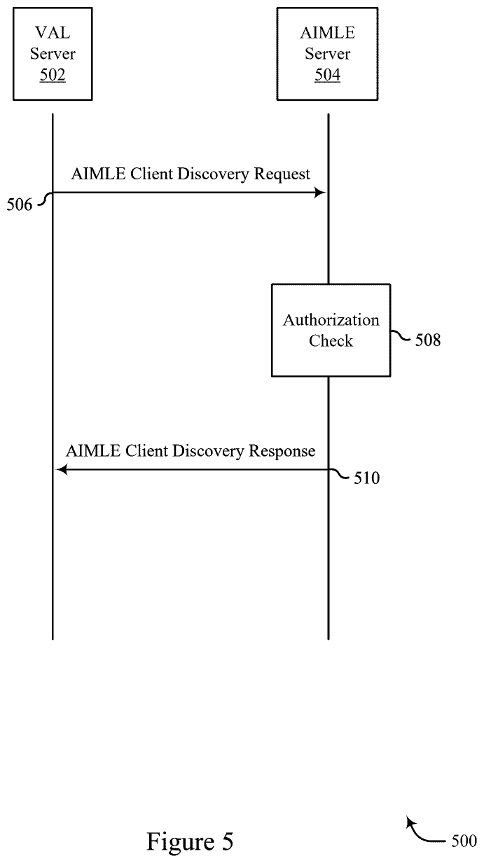

FIG. 5 illustrates an example of a process flow 500 in accordance with aspects of the present disclosure. The process flow 500 may be performed by a VAL server 502 and an AIMLE server 504.

Steps 506 through 510 may relate to an AIMLE client discovery service. The AIMLE client discovery service may allow the VAL server 502 to discover available AIMLE clients for AIML services (e.g., training or interference). The AIMLE server 504 may provide functionality to the VAL server 502 to select suitable AIMLE clients that fulfill discovery criteria. In some examples, prior to 506, one or more AIMLE clients that support AIML operations may register with the AIMLE server 504 and provide a respective AIMLE client profile and respective list of supported services. Additionally, prior to 506, the AIMLE server 504 may obtain access to a ML repository in order to obtain the AIMLE client profiles and lists of supported services associated with the one or more AIMLE clients. Further, prior to 506, the VAL server 502 may receive an access token from an authorization server as described in FIG. 2. The access token may include some or all of the information presented in Table 16.

At 506, the VAL server 502 may transmit an AIMLE client discovery request (or a fifth message) to an AIMLE server 504 to discover a list of AIMLE clients that are available to participate in AIML services (e.g., are available to train an ML model). The AIMLE client discovery request may include security credentials (e.g., client certificates and/or root certificate to validate the client certificate) and the access token. Further, the AIMLE client discovery requirement may include AIML client task capability requirements to discover clients who can perform the AIML tasks like AIML model training, model offload, or model split with compute requirements and a task performance preference like green task performance.

At 508, the AIMLE server 504 may perform authentication and authorization checks based on the security credentials and access token to determine if the requestor is able to discover AIMLE clients. If the requestor is authorized, the AIMLE server 504 may obtain a list of candidate AIMLE clients from the ML repository. From the list of candidate AIMLE clients, the AIMLE server 504 may discover a list of AIMLE clients that fulfils the discovery criteria based on supported services and AIMLE client profiles. The AIMLE server 504 may then determine whether the discovered AIMLE clients fulfil location information specified in the discovery criteria and select AIMLE clients that meet the location requirement. In some examples, the AIMLE server 504 may use SEAL-location management server (LMS) to determine the AIMLE client that fulfils the location requirement. If the selected AIMLE clients are less than a minimum quantity of AIMLE clients for AIML service, the AIMLE server 504 may discover and select other AIMLE clients from other AIMLE servers 504 over an AIML-E interface.

At 510, the AIMLE server 504 may transmit an AIMLE client discovery response (or a sixth message) to the VAL server 502 based on the information in the access token. In some examples, the AIMLE client discovery response may include the AIMLE clients selected by the AIMLE server 504 at 508. Additionally, the AIMLE client discovery response may include information related to supported tasks with guaranteed task key performance indicators (KPIs), available AIML tasks service duration, or AIML task expected KPI (e.g., latency). If a minimum quantity of AIMLE clients are not included in the AIMLE client discovery response, the VAL server 502 may discover other AIMLE clients from other AIMLE servers 504.

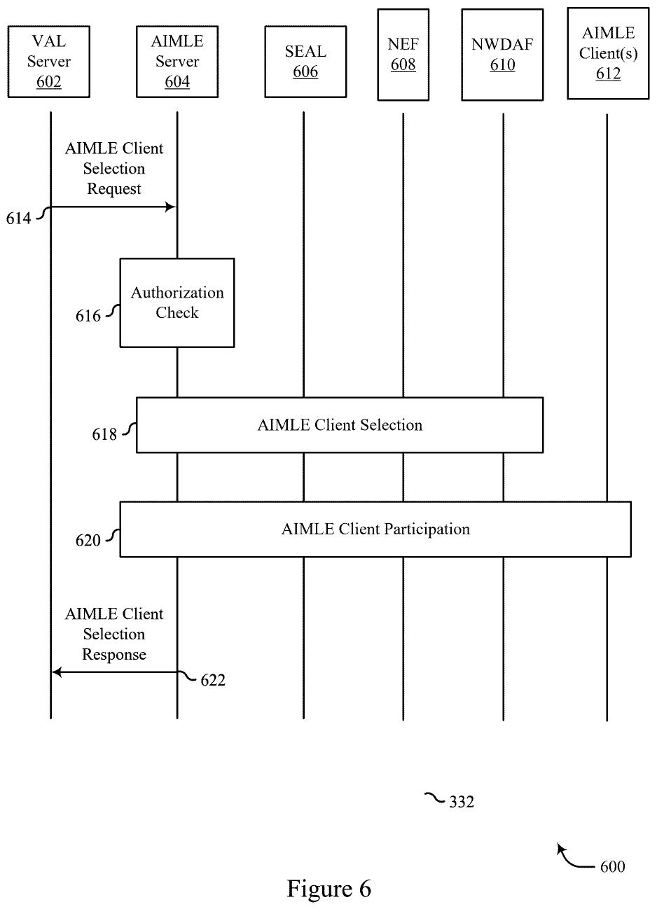

FIG. 6 illustrates an example of a process flow 600 in accordance with aspects of the present disclosure. The process flow 600 may be performed by a VAL server 602, an AIMLE server 604, SEAL 606, network exposure function (NEF) 608, network data analytics function (NWDAF) 610, and AIMLE client(s) 612.

Steps 614 through 622 may relate to an AIMLE client selection service. In some examples, prior to 614, one or more AIMLE clients 612 that support AIML operations may have registered with the AIMLE server 604 and provided a respective AIMLE client profile and respective list of supported services. Additionally, prior to 614, the AIMLE server 604 may obtain access to a ML repository in order to obtain the AIMLE client profiles and lists of supported services associated with the one or more AIMLE clients 612. Further, prior to 614, the VAL server 602 may receive an access token from an authorization server as described in FIG. 2. The access token may include some or all of the information presented in Table 17.

At 614, the VAL server 602 may transmit an AIMLE client selection request (or a seventh message) to the AIMLE server 604 to select AIMLE clients 612 available for participation in AIML services (e.g., are available to train an ML model). The AIMLE client selection request may include security credentials (e.g., client certificates and/or root certificate to validate the client certificate) and the access token.

At 616, The AIMLE server 604 may perform authentication based on the security credentials and performs authorization checks by validating the access token claims to determine if the requestor is able to select AIMLE clients 612.

At 618, if the VAL server 602 is authorized, the AIMLE server 604 may perform AIMLE client selection. For VAL server selection, the AIMLE server 604 may receive a list of AIMLE client IDs in the AIMLE request and select the AIMLE clients 612 in the list as candidate AIMLE clients 612. For AIMLE server selection, the AIMLE server 604 may retrieve a list of AIMLE clients 612 with AIML capabilities from the ML repository. From the list of AIMLE clients 612, the AIMLE server 604 may select a list of candidate AIMLE clients 612 whose client profiles fulfil the AIMLE client selection criteria. In some examples, the AIMLE server 604 may use SEAL 606 (LM service), NEF 608 (e.g. MonitoringEvent API), and NWDAF 610 capabilities to assist the AIMLE client selection.

The AIMLE server 604 may determine the AIMLE clients 612 by using corresponding AIMLE IDs to determine location of the AIMLE clients 612 and select those that fulfil the location requirements specified in AIMLE client selection criteria. In some examples, the AIMLE server 604 may use SEAL-LMS to determine the UEs which fulfil the location requirement. The AIMLE server 604 may then determine quality of service (QoS) parameters for an AIML traffic session between the requestor and the candidate AIMLE client(s) and configure the AIML traffic session via SEALDD (Sdd_RegularTransmission API) or NEF services (AfSessionWithQoS API). The AIMLE server 604 determines the application QoS parameters based on the VAL Service ID.

At 620, the AIMLE server 604 may perform AIMLE client participation procedure with each candidate AIMLE client 612. For all candidate AIMLE clients 612 that agree to participate in AIML services, the AIMLE server 604 selects the AIMLE clients and assigns an AIMLE client set ID for the selected AIMLE clients 612. The AIMLE client set may then be used for training an ML model.

At 622, the AIMLE server 604 may transmit an AIMLE client selection response (or an eighth message) to the VAL server 602. In some examples, the AIMLE client selection response may include the AIMLE client set ID and a list of AIMLE client IDs.

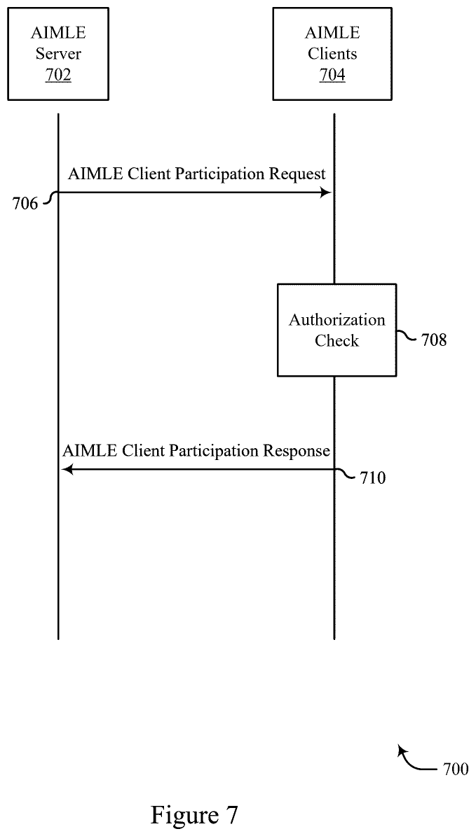

FIG. 7 illustrates an example of a process flow 700 in accordance with aspects of the present disclosure. The process flow 700 may be performed by an AIMLE server 702 and an AIMLE client 704.

Steps 706 through 710 may relate to an AIMLE client participation service. The AIMLE client participation service may allow an AIMLE server 702 to verify and manage participation of AIMLE clients 704 in AIML services. In some examples, prior to 706, the AIMLE server 702 may receive an access token from an authorization server as described in FIG. 2. The access token may include some or all of the information presented in Table 18.

At 706, the AIMLE server 702 may transmit an AIMLE client participation request (or a ninth message) to the AIMLE client 704 to verify participation in AIML services. The request may include security credentials (e.g., client certificates and/or root certificate to validate the client certificate) and the access token.

At 708, the AIMLE client 704 may authenticate the AIMLE client participation request based on the security credentials and validate authorization based on the access token. If verification is successful, the AIMLE client 704 acknowledge its willingness to be part of (or be removed from) the AIMLE client set.

At 710, the AIMLE client 704 transmits an AIMLE client participation response (or a tenth message) to the AIMLE server 702. In some examples, the AIMLE client participation response may include an indication of the AIMLE client's willingness to be part of (or be removed from) the AIMLE client set.

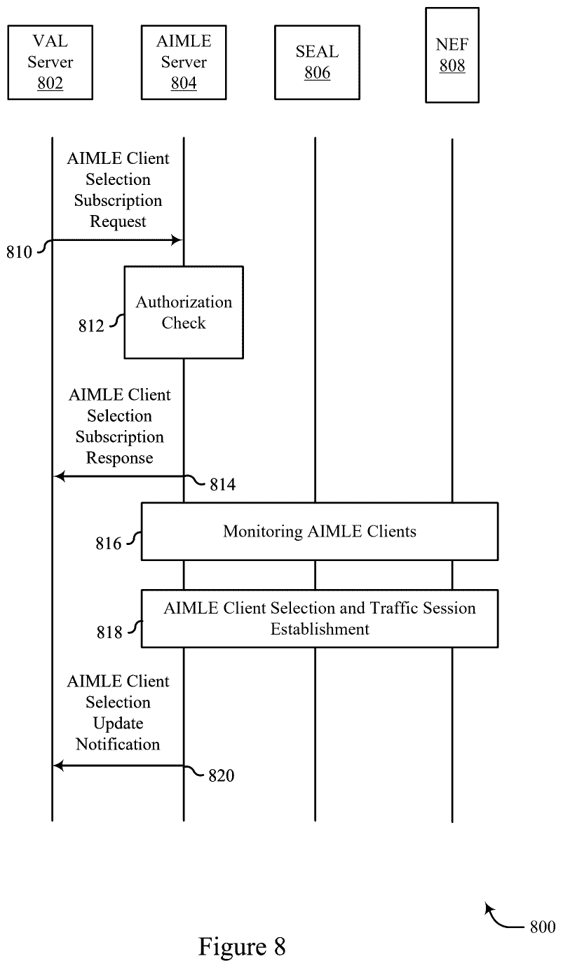

FIG. 8 illustrates an example of a process flow 800 in accordance with aspects of the present disclosure. In some examples, the process flow 800 may be performed by a VAL server 802, an AIMLE server 804, SEAL 806, and NEF 808.

Steps 810 through 820 may relate to an AIMLE client subscription service. In some examples, prior to 810, the VAL server 802 may receive an access token from an authorization server as described in FIG. 2. The access token may include some or all of the information presented in Table 19.

At 810, the VAL server 802 sends an AIMLE client selection subscription request (or an eleventh message) to the AIMLE server 804. The AIMLE client selection subscription request may include selection criteria, security credentials (e.g., client certificates and/or root certificate to validate the client certificate), and the access token.

At 812, the AIMLE server 804 validates the AIMLE client selection subscription request. The AIMLE server further performs authentication and authorization checks based on the security credentials and the access token to determine if the VAL server 802 is able to subscribe to the selected AIMLE client selection subscription request.

At 814, the AIMLE server 804 may transmit a client selection subscription response (or a twelfth message) to the VAL server 802. The client selection subscription response may include one or more of a status of the request (e.g., successful or failed), a subscription ID, or an expiration time.

At 816, the AIMLE server 804 may monitor AIMLE clients whether the AIMLE clients fulfil the selection criteria. The AIMLE server 804 may interact with the NEF 808 and/or the SEAL 806 to establish monitoring. The AIMLE server 804 may utilize SEAL-LMS or 3GPP 5G Core Network Services to establish monitoring of the AIMLE clients entering or present in a target location provided in the location information in the selection criteria.

At 818, the AIMLE server 804 may obtain IDs of the AIMLE clients from the monitoring and select the AIMLE clients that fulfil the selection criteria and remove the AIMLE clients which do not fulfil the selection criteria. The AIMLE server 804 uses location monitoring for selecting AIMLE clients that fulfil the location criteria and remove AIMLE clients which cease to fulfil the location criteria as provided in the location information in the selection criteria. The AIMLE server 804 may determine the application QoS parameters (e.g. bandwidth, latency, jitter) for the AIML traffic session between the VAL server 802 and the selected AIMLE client and configure the AIML traffic session(s) via SEALDD or NEF services. When the AIMLE clients no longer meet the selection criteria, the QoS adjustment may be reversed.

The AIMLE server 804 may determine the application QoS parameters based on the VAL Service ID. If a desired service in the selection criteria is no longer provided by the AIMLE client or its profile change so that it no longer meets the selection criteria, the AIMLE server 804 removes the AIMLE clients which ceases to fulfil the criteria and selects other AIMLE clients that fulfil selection criteria.

At 820, the AIMLE server 804 may transmit an AIMLE client selection update notification to notify the VAL server 802 about selected or re-selected AIMLE clients.

The VAL server 802 may perform similar operations during an AIMLE client subscription update service. Prior to performing the AIMLE client subscription update service, the AIMLE client or VAL server 802 may be subscribed for AIMLE client selection with the AIMLE server 804. Further, prior to performing the AIMLE client subscription update service, the VAL server 802 may receive an access token from an authorization server as described in FIG. 2. The access token may include some or all of the information presented in Table 19.

During the AIMLE client subscription update service, the VAL server 802 may transmit a AIMLE client selection subscription update request to the AIMLE server 804. The AIMLE client selection subscription update request may include a subscription ID, security credentials (e.g., client certificates and/or root certificate to validate the client certificate), and the access token.

Upon receiving the AIMLE client subscription update request from the VAL server 802, the AIMLE server 804 may authenticate the VAL server 802 based on the received security credentials and determine if the VAL server 802 is authorized for the request based on the access token. If the verification is successful, the VAL server 802 may be considered as successfully authorized, and the AIMLE server 804 may update the subscription.

The AIMLE server 804 then sends an AIMLE client selection subscription update response to the VAL server 802. If the AIMLE server 804 updated the subscription, the AIMLE client subscription update response may include an indication of success. If the AIMLE server 804 does not update the subscription, the AIMLE client subscription update response may include an indication of failure and may include a reason for failure.

The VAL server 802 may perform similar operations during an AIMLE client unsubscribe service. Prior to performing the AIMLE client unsubscribe service, the AIMLE client or VAL server 802 may be subscribed for AIMLE client selection with the AIMLE server 804. Further, prior to performing the AIMLE client unsubscribe service, the VAL server 802 may receive an access token from an authorization server as described in FIG. 2. The access token may include some or all of the information presented in Table 19.

During the AIMLE client unsubscribe service, the VAL server 802 may transmit an AIMLE client unsubscribe request to the AIMLE server 804. The AIMLE client unsubscribe request may include a subscription ID, security credentials (e.g., client certificates and/or root certificate to validate the client certificate), and the access token.

Upon receiving the AIMLE client unsubscribe request from the VAL server 802, the AIMLE server 804 may authenticate the VAL server 802 based on the received security credentials and determine if the VAL server 802 is authorized for the request based on the access token. If the VAL server 802 is authorized, the AIMLE server 804 may unsubscribe the VAL server 802 from the subscription.

The AIMLE server 804 may transmit an AIMLE client selection unsubscribe response to the VAL server 802. If the AIMLE server 804 has unsubscribed the VAL server 802 from the subscription, the AIMLE client selection unsubscribe response may include an indication of success. If the AIMLE server 804 has not unsubscribed the VAL server 802 from the subscription, the AIMLE client selection unsubscribe response may include an indication of failure and may include a reason for the failure.

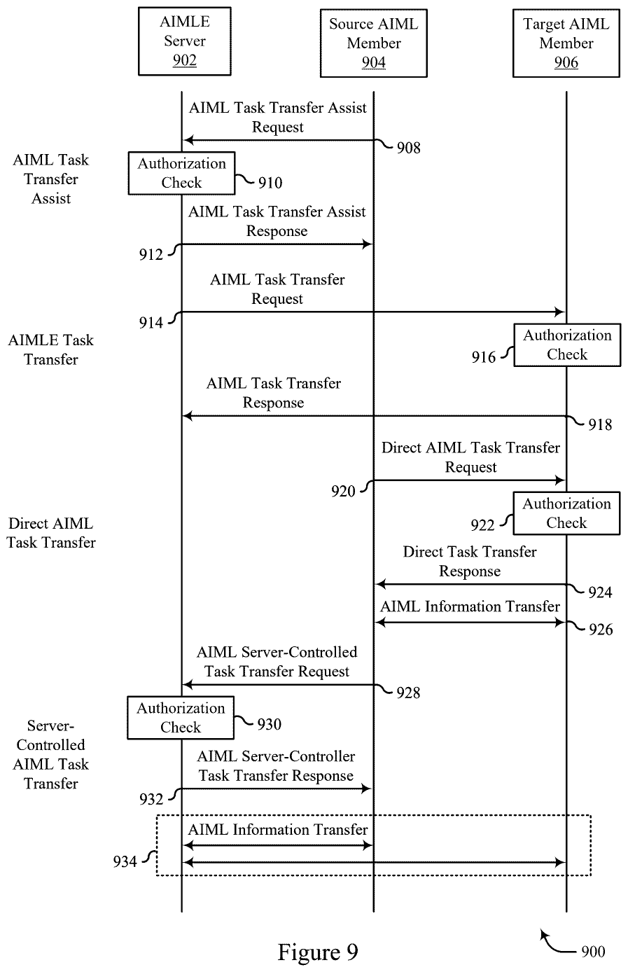

FIG. 9 illustrates an example of a process flow 900 in accordance with aspects of the present disclosure. In some examples, the process flow 900 may be performed by an AIMLE server 902, a source AIML member 904, and a target AIML member 906.

Steps 908 through 912 may relate to an AIML task transfer assist service. In some examples, prior to 908, information relating to the target AIML member 906 (e.g., AIMLE client or VAL client different from the source AIML member 904) may be unknown to the source AIML member 904. Additionally, prior to 908, the source AIML member 904 may determine which AIML tasks to transfer. For example, if the AIML task includes model training, one or more AIML models are obtained by the source AIML member 904. Further, prior to 908, the source AI/ML member may receive an access token from an authorization server as described in FIG. 2. The access token may include some or all of the information presented in Table 20.

At 908, the source AIML member 904 (e.g., an AIMLE client) may transmit an AIML task transfer assist request to the AIMLE server 902 for assisting AIML task transfer. The AIML task transfer assist request message may include security credentials and the access token.

At 910, the AIMLE server 902 may validate the AIML task transfer assist request and perform an authentication and authorization check based on the received security credentials and access token to determine if the source AIML member 904 is permitted to request the AIML task transfer for the indicated scope in the access token. Upon successful authorization, the AIMLE server 902 may discover other AIML members (e.g., other AIMLE Clients) directly or via a ML repository and select an AIML members based on the request from the source AIML member 904. The AIMLE server 902 may transmit a request to the selected target AIML member 906 for the AIML task transfer. Further, the security credentials and the access token received from the source AIML member 904 may be forwarded to the target AIML member 906 and if available, the target AIML member 906 may obtain its own security credentials and access token. The AIMLE server 902 may also determine a transfer mode (e.g., transfer with server-controlled or transfer directly from the source AIML member 904 to the target AIML member 906 based on the access token. If the target AIML member 906 is discovered by the AIMLE server 902, the AIMLE server 902 may generate assistance information for AIML task transfer from the source AIML member 904 to the target AIML member 906 (e.g., time window for task transfer.)

At 912, the AIMLE server 902 sends an AIML task transfer assist response to the source AIML member 904 with information related to the target AIML member 906 (e.g., an ID of the target AIML member 906) and the assistance information.

Steps 914 through 918 may relate to an AIML task transfer service. In some examples, prior to 914, the AIMLE server 902 may receive an access token from an authorization server as described in FIG. 2. The access token may include some or all of the information presented in Table 20.

At 914, The AIMLE Server sends an AIML task transfer request to a target AIML member 906 for AIML task transfer. The AIML task transfer request may include security credentials and the access token.

At 916, the target AIML member 906 may authenticate and authorize the request from the AIMLE server 902 based on the security credentials and the access token. If the verification is successful, the target AIML member 906 considers the request successfully authorized.

At 918, the target AIML member 906 may transmit an AIML task transfer response based on the access token to the AIMLE server 902. The AIML task transfer response may include a status of the AIML task transfer request (e.g., success or failure) and an AIML task transfer time.

Steps 920 through 926 may relate to a direct AIML task transfer service. In some examples, prior to 920, information related to the target AIML member 906 may be known by the source AIML member 904. The source AIML member 904 may determine to transfer the AIML task to the target AIML member 906. Additionally, prior to 920, the source AIML member 904 may receive an access token from an authorization server as described in FIG. 2. The access token may include some or all of the information presented in Table 20.

At 920, the source AIML member 904 may transmit a direct AIML task transfer request to the target AIML member 906 for direct AIML task transfer. The AIML task transfer request may include security credentials and the access token.

At 922, the target AIML member 906 may authenticate and authorize the direct AIML task transfer request from the source AIML member 904 based on the security credentials and the access token. If the direct AIML task transfer request is authorized, the target AIML member 906 may check its availability to continue AIML operations (e.g., available resources and time).

At 924, the target AIML member 906 may transmit a direct AIML task transfer response based on the access token to the source AIML member 904. In some examples, the AIML task transfer response may include a status of the direct AIML task transfer request (e.g., success or failure).

At 926, the source AIML member 904 may interact with the target AIML member 906 to perform AIML task transfer to the target AIML member 906.

Steps 928 through 934 may relate to an AIMLE server-controlled AIML task transfer service. In some examples, prior to 928, information relating to the target AIML member 906 may be unknown to the source AIML member 904. The source AIML member 904 may determine that AIMLE server-controlled task transfer is needed. Further, prior to 928, the source AI/ML member 904 may receive an access token from an authorization server as described in FIG. 2. The access token may include some or all of the information presented in Table 20.

At 928, the source AI/ML member 904 may send an AIMLE server-controlled AIML task transfer request to the AIMLE server 902. The AIMLE server-controlled AIML task transfer request may include security credentials and the access token.

At 930, the AIMLE server 902 may authenticate and authorize the AIMLE server-controlled AIML task transfer request from the source AIML member 904 based on the security credentials and the access token. If the request is authorized, the AIMLE server 902 may check the availability of the target AIML member 906 for the AI/ML task transfer. Further, the AIMLE server 902 may generate assistance information for the transfer of AIML task from the source AIML member 904 to the target AIML member 906 via the AIMLE server 902 (e.g. time window for the transfer).

At 932, the AIMLE server 902 may transmit AIMLE server-controlled AIML task transfer response based on the access token to the source AIML member 904. In some examples, the AIMLE server-controlled AIML task transfer response may include a status of the AIMLE server-controlled AIML task transfer request (e.g., success or failure) and the assistance information.

At 934, the source AIML member 904 may perform AIML task transfer to the target AIML member 906 via the AIMLE server 902 based on the information included in the AIMLE server-controlled AIML task transfer response.

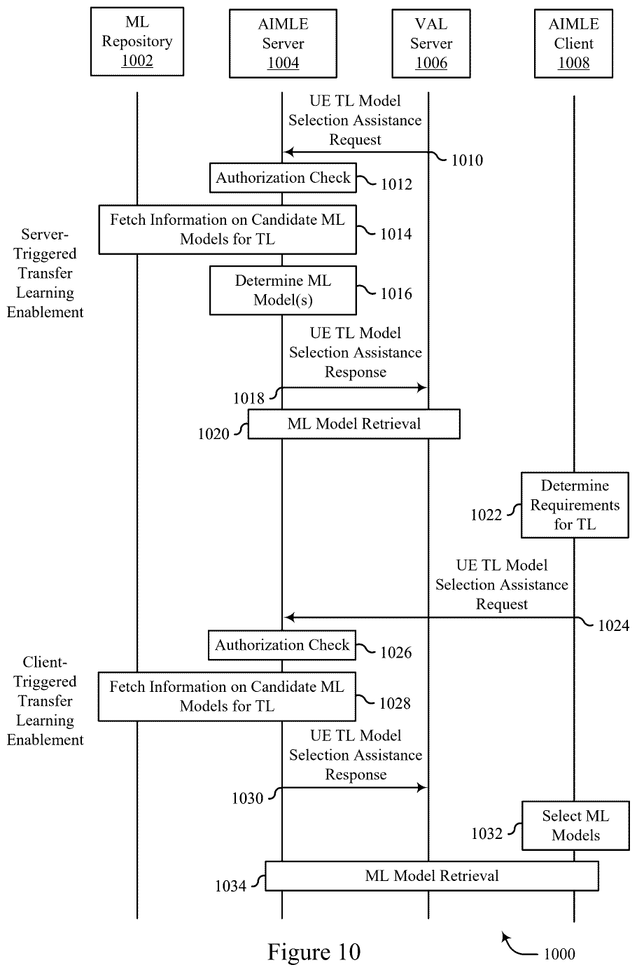

FIG. 10 illustrates an example of a process flow 1000 in accordance with aspects of the present disclosure. In some examples, the process flow 1000 may be performed by an ML repository 1002, an AIMLE server 1004, a VAL server 1006, and an AIMLE client 1008.

Steps 1010 through 1020 may relate to a server-triggered transfer learning enablement service. In some examples, prior to 1010, the VAL server 1006 may be connected to the AIMLE server 1004. Further, prior to 1010, the VAL server 1006 may receive an access token from an authorization server as described in FIG. 2. The access token may include some or all of the information presented in Table 21.

At 1010, the VAL server 1006 may transmit a transfer learning model selection assistance request message to the AIMLE server 1004 to provide support for discovering and selecting an appropriate pre-trained ML model for a given ML task (e.g., for an ADAE analytics ID or a certain ML model ID). In some examples, the transfer learning model selection assistance request message may include security credentials and the access token.

At 1012, the AIMLE server 1004 may perform authentication and authorization checks based on the security credentials and the access token to determine if the VAL server 1006 is authorized to request transfer learning model selection assistance. If the VAL server 1006 is authorized, the AIMLE server 1004 may discover the possible entities (e.g., other VAL server, other ADAES, or other AIMLE server) which can provide a pre-trained models for this request.

At 1014, the AIMLE server 1004 may request one or more pre-trained ML models which can be used for transfer learning for a target ML task by providing the security credentials and the access token received from the VAL server 1006 to the ML repository 1002. The ML repository 1002 may perform authentication and authorization checks based on the security credentials and the access token to determine if the request can be processed. If the VAL server 1006 and the AIMLE server 1004 is authorized, the ML repository 1002 may identify a base ML model as a pre-trained ML model that can be mapped to the target ML task and send information on the pre-trained model to AIMLE server 1004 which may be a candidate as a pre-trained model available for the target ML task.

At 1016, the AIMLE server 1004 may evaluate, with the support of the ML repository 1002, whether the pre-trained model is applicable to the target ML task based on historical data or ML model rating. Based on the evaluation, the AIMLE server 1004 determines that the pre-trained model may be used for the target ML task.

At 1018, the AIMLE server 1004 may transmit, to the VAL server 1006, a transfer learning selection assistance response based on the access token. The transfer learning selection assistance response may include information related to the selected pre-trained model (e.g., model ID, profile) for the target ML task. The transfer learning selection assistance response may also include a rating or weight for each selected pre-trained model if the AIMLE server 1004 provides multiple pre-trained models. The ratings or weights may assist the VAL server 1006 in selecting a pre-trained model among the multiple pre-trained models for the target ML task.

At 1020, based on the pre-trained model information provided in the transfer learning selection assistance response, the VAL server 1006 may retrieve the selected pre-trained model from the AIMLE server 1004.

Steps 1022 through 1034 may relate to a client-triggered transfer learning enablement service. In some examples, prior to 1022, the AIMLE client 1008 may be connected to the AIMLE server 1004. Further, prior to 1022, the AIMLE client 1008 may receive an access token from an authorization server as described in FIG. 2. The access token may include some or all of the information presented in Table 22.

At 1022, the AIMLE client 1008 may determine a requirement for using a pre-trained ML model for transfer learning for a UE-triggered ML task (e.g., UE analytics event).

At 1024, the AIMLE client 1008 may transmit a UE transfer learning model selection assistance request to the AIMLE server 1004 to receive one or more pre-trained ML models which can be used for transfer learning for the target UE-triggered ML task. The UE transfer learning model selection assistance request may include security credentials and the access token.

At 1026, the AIMLE server 1004 may perform authentication and authorization checks based on the security credentials and the access token to determine if the AIMLE client 1008 is authorized to request transfer learning model selection assistance.

At 1028, if the AIMLE client 1008 is authorized, the AIMLE server 1004 may request one or more pre-trained ML models which can be used for transfer learning for the target UE-triggered ML task by providing the security credentials and the access token received from the AIMLE client 1008 to the ML repository 1002. The ML repository 1002 may perform authentication and authorization checks based on the security credentials and access token to determine if the request can be processed. If the AIMLE client 1008 and the AIMLE server 1004 are authorized, the ML repository 1002 may identify a base ML model as a pre-trained ML model that can be mapped to the target UE-triggered ML task and send information on pre-trained model to AIMLE server 1004 which may be a candidate as pre-trained model available for the target UE-triggered task.

At 1030, the AIMLE server 1004 sends a UE transfer learning model selection assistance response based on the access token to the AIMLE client 1008. The includes transfer learning model selection assistance response may include information related to the pre-trained model for the target ML task. Such models may be pre-trained for an ADAES analytics task (e.g., VAL server performance analytics) and are applicable to be used for the VAL UE analytics task (e.g. VAL session performance analytics).

At 1032, the AIMLE client 1008 may evaluate whether the pre-trained model is applicable to the target UE-triggered ML task. Based on the evaluation, the AIMLE client 1008 selects a base model to be used as pre-trained model for the UE-triggered ML task.

At 1034, based on the pre-trained model information provided in the UE transfer learning selection assistance response, the AIMLE client 1008 may retrieve the selected pre-trained model from the AIMLE server 1004.

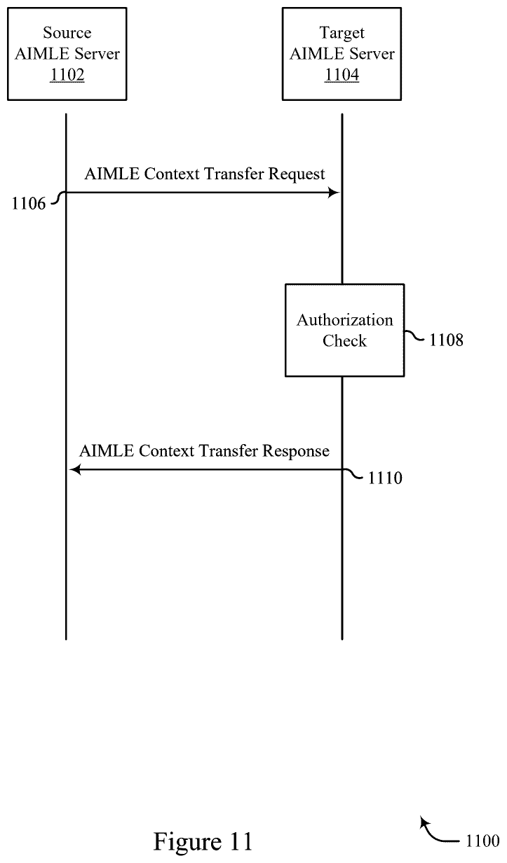

FIG. 11 illustrates an example of a process flow 1100 in accordance with aspects of the present disclosure. In some examples, the process flow 1100 may be performed by a source AIMLE server 1102 and a target AIMLE server 1104.

Steps 1106 through 1110 may relate to an AIMLE context transfer procedure. In some examples, prior to 1110, each of the source AIMLE server 1102 and the target AIMLE server 1104 may manage clients within its respective service area to perform AIML operations. In some examples, a UE associated with an AIMLE client may move from a source service area managed by the source AIMLE server 1102 to a target service area managed by a target AIMLE server 1104. The transition from the source service area to the target service area may trigger an application context relocation (ACR) procedure between the two AIMLE servers. Further, prior to 1110, the source AIMLE server 1102 may receive an access token from an authorization server as described in FIG. 2. The access token may include some or all of the information presented in Table 23.

At 1106, the source AIMLE server 1102 may transmit an AIMLE context transfer request to the target AIMLE server 1104. The AIMLE context transfer request may include security credentials, the access token, and AIMLE context information.

At 1108, the target AIMLE server 1104 may perform authentication and authorization checks based on the security credentials and access token to determine if the AIMLE context transfer request can be processed. If the source AIMLE server 1102 is authorized, the AIMLE context information is used by the target AIMLE server 1104 to determine whether information (e.g. AI/ML operation output/result) received from an AIMLE client may be transferred to the source AIMLE server 1102. For example, the target AIMLE server 1104 may forward the AIMLE service results received from the AIMLE client to the source AIMLE server 1102 if the results are only applicable to the source service area or the AIMLE client is part of a split operation pipeline formed in the source service area.

At 1110, the target AIMLE server 1104 may transmit an AIMLE context transfer response based on the access token to the source AIMLE server 1102.

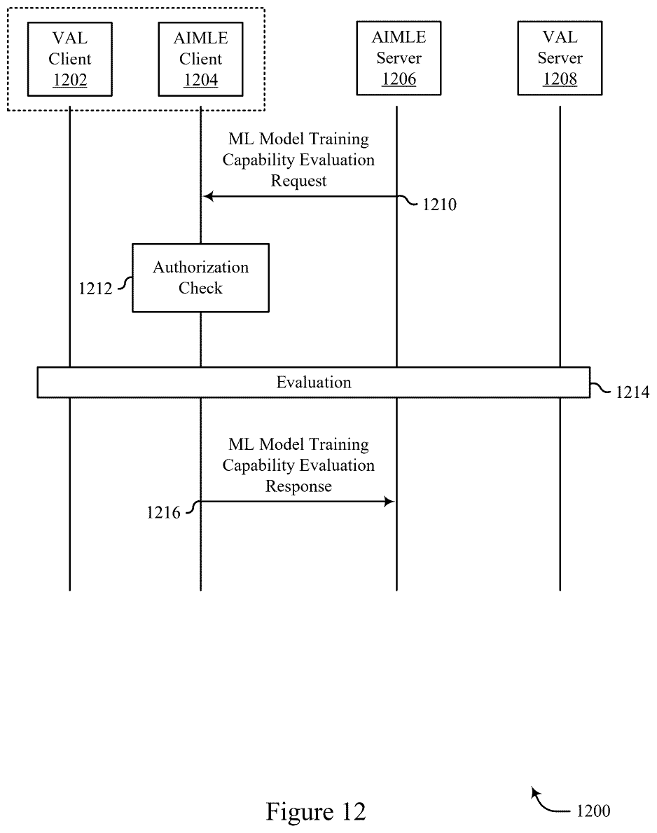

FIG. 12 illustrates an example of a process flow 1200 in accordance with aspects of the present disclosure. In some examples, the process flow 1200 may be performed by a VAL client 1202, an AIMLE client 1204, an AIMLE server 1206, and a VAL server 1208.

Steps 1210 through 1216 may relate to ML model training capability evaluation. Additionally, steps 1210 through 1216 support authorized ML model training capability evaluation for FL (e.g., HFL, VFL). A ML model training capability result may be used by the AIMLE server 1206 (e.g., an authorized AIMLE server 1206) to select FL member for FL training processes (e.g., HFL, VFL). In some examples, prior to 1210, the AIMLE server 1206 may determine to use FL (e.g., HFL, VFL) training and know information about FL (e.g., HFL, VFL) members (e.g., the AIMLE client 1204 which is deployed to a UE). In addition, the AIMLE server 1206 may receive an access token from an authorization server as described in FIG. 2. The access token may include some or all of the information presented in Table 24.

At 1210, the AIMLE server 1206 sends an ML model training capability evaluation request to the FL members (e.g., the AIMLE client 1204 and other AIMLE clients which are deployed on UEs). The ML model training capability evaluation request may include selection criteria, security credentials (e.g., client certificates and/or root certificate to validate the client certificate), and the access token.

At 1212, the AIMLE client 1204 validates the ML model training capability evaluation request. The ML model training capability evaluation request may include a requestor ID, security credentials (e.g., client certificates and/or root certificate to validate the client certificate), and the access token. The AIMLE client 1204 further performs authentication and authorization checks based on the security credentials and the access token to determine if the AIMLE client 1204 is able to subscribe to the ML model training capability evaluation request.

At 1214, the AIMLE client 1204 and other FL members (e.g., AIMLE clients which are deployed on UEs) may perform an evaluation of capability, availability, and data alignment. That is, the AIMLE client 1204 may perform authentication and authorization checks based on security credentials and authorization information and the access token. If the requestor is authorized (e.g., if the AIMLE client 1204 verifies the received security credentials including authentication information such as certificates, the claims in the authorization information or access token, and if the verification is successful), the AIMLE client 1204 may evaluate its capability and availability to join the FL training process. The AIMLE client 1204 may run a test task included in the ML model training capability evaluation request and determine whether the AIMLE client 1204 may join the FL process. For VFL, as part of the test task, data alignment between the datasets of the different domains may be determined. The VAL server 1208 may also provide data labels for the data alignment.

In some examples, procedures for data collection from a UE take user consent into account. Where a resource owner ID claim in the access token confirms that user consent is provided, the AIMLE client 1204 may verify that the indicated resource owner ID matches a correct GPSI or UE ID.

At 1216, the AIMLE client 1204 may send an ML model training capability evaluation response to the AIMLE server 1206. The ML model training capability evaluation response may include information such as a status for the evaluation (e.g., success, meaning the AIMLE client 1204 may join the FL training process, or fail, meaning the AIMLE client 1204 may not join the FL training process), a test respond of the ML model training capability evaluation (indicated when the status is “success,”), a fail reason if the ML model training capability evaluation fails (indicated when the status is “fail”), and so forth.

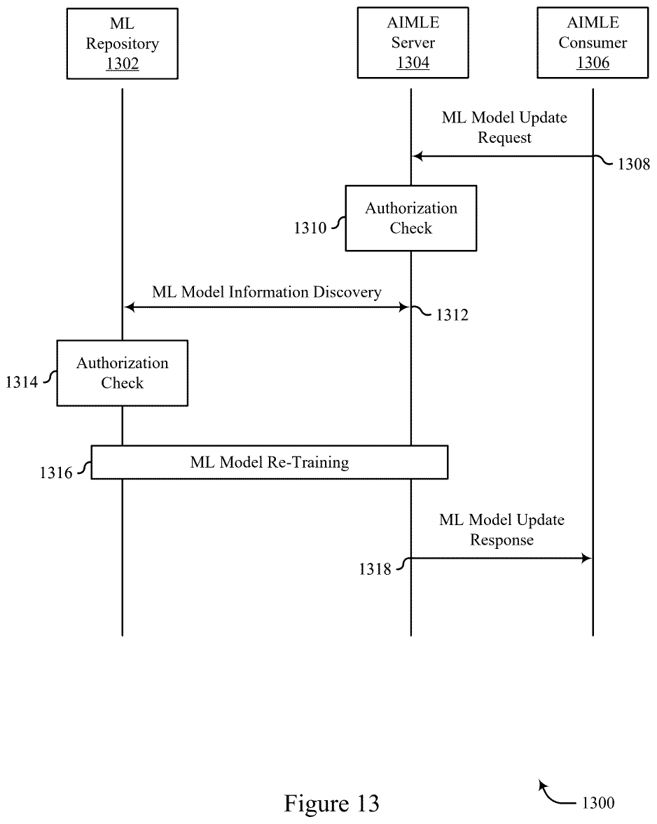

FIG. 13 illustrates an example of a process flow 1300 in accordance with aspects of the present disclosure. In some examples, the process flow 1300 may be performed by an ML repository 1302, an AIMLE server 1304, and an AIMLE consumer 1306 (e.g., an AIMLE client, a VAL server, an ADAE server, or a VAL UE).

Steps 1308 through 1318 may relate to an ML model update. Additionally, steps 1308 through 1318 support authentication and authentication verification of a VAL server by the AIMLE server 1304, and support services related to the updating of trained and deployed ML models by detecting model performance degradation and triggering ML model re-training and updating to fix the observed degradation for specific ML models. In this way, steps 1308 through 1318 support ML model re-training and updating when model performance degradation is observed by the AIMLE layer. Such model re-training and updating may include using an existing ML model to re-train an ML model using transfer learning. Additionally, if the degraded ML model is related to other models (e.g., due to transfer learning), the AIMLE server 1304 may trigger the update of such related ML models as well. In some examples, the AIMLE server 1304 may receive an access token from an authorization server as described in FIG. 2. The access token may include some or all of the information presented in Table 25.

At 1308, the AIMLE consumer 1306 sends an ML model update request to the AIMLE server 1304. The ML model update request may include a requestor identity, security credentials (e.g., client certificates and/or root certificate to validate the client certificate), and the access token.

At 1310, the AIMLE server 1304 performs authentication and authorization checks based on the security credentials and the access token (e.g., authorization information). If the requestor is authorized (i.e., if the AIMLE server 1304 verifies the received security credentials including certificates, and if the verification is successful), then the AIMLE server 1304 may perform the requested service. For example, based on the performance degradation information, the AIMLE server 1304 may determine whether to update the ML model. If the AIMLE server 1304 refrains from updating the model, steps 1312 through 1316 may be skipped.

At 1312, the AIMLE server 1304 may retrieve ML model information from the ML repository 1302. In addition, the AIMLE server 1304 may include its own security credentials (e.g., certificates, authorization tokens, access tokens). The AIMLE server 1304 may perform ML model discovery by including its own security credentials in the ML repository 1302, for example, to determine whether an existing ML model stored at the ML repository 1302 may be used to replace a degraded ML model or train a new ML model (e.g., using transfer learning) related to the ML model update request from the AIMLE consumer 1306.

At 1314, the ML repository 1302 may perform authentication and authorization checks based on the security credentials and the access token to determine if the AIMLE server 1304 is able to subscribe to the ML model update request. If the AIMLE server 1304 is authorized, then the ML repository 1302 may perform the requested service. For example, if an existing ML model may be used to replace the degraded model, step 1316 may be skipped, and the AIMLE server 1304 may provide the identified model in step 1318. In some examples, the AIMLE server 1304 may also discover ML models that are related due to transfer learning or the use of the same or similar training data, to identify additional models that may require updating.

At 1316, the AIMLE server 1304 may perform ML model re-training, which may include various ML model training procedures. The updated (i.e., re-trained) ML model may be stored in the ML repository 1302 once the re-training is complete.

At 1318, the AIMLE server 1304 may send (i.e., provide) an ML model update response including the updated ML model to the AIMLE consumer 1306. The AIMLE server 1304 may send the ML model update response and the updated ML model either directly or by providing endpoint information for retrieving the updated ML model from the ML repository 1302. By way of example, the ML model update response may include a successful response indicating that the ML model update request succeeded and that the ML model has been updated. The successful response may include the updated ML model, the ML model retrieval endpoint (e.g., a URL, URI, or IP address where the ML model may be retrieved), ML model information, or any combination thereof. Alternatively, the ML model update response may include a failure response, indicating that the ML model update request failed. In such cases, the failure response may indicate a cause of the failure.

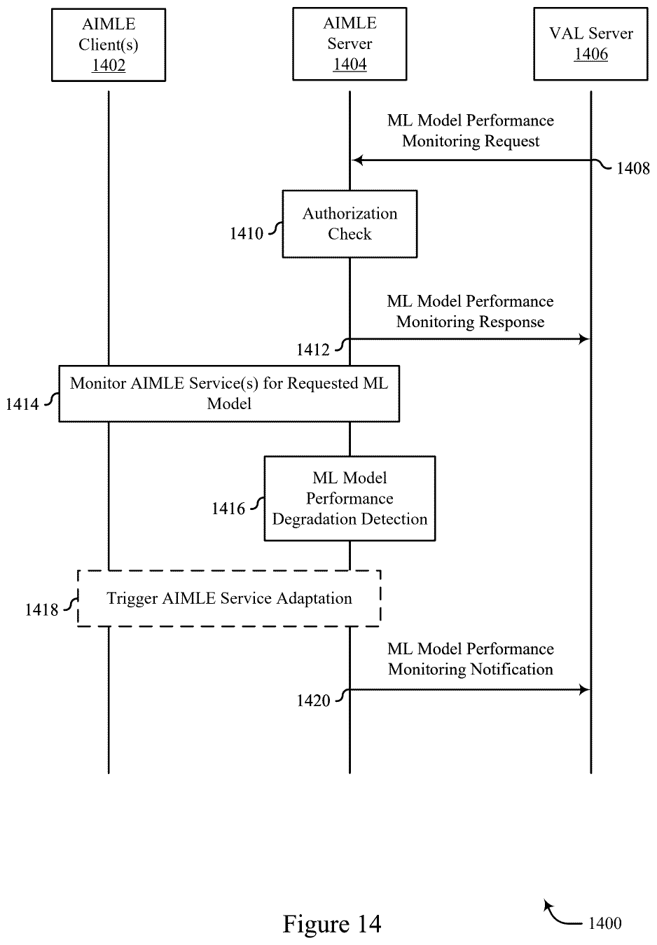

FIG. 14 illustrates an example of a process flow 1400 in accordance with aspects of the present disclosure. In some examples, the process flow 1400 may be performed by an AIMLE client 1402, an AIMLE server 1404, and a VAL server 1406.

Steps 1408 through 1420 may relate to ML model performance monitoring. Additionally, steps 1408 through 1420 support authentication and authentication verification of a VAL server by the AIMLE server 1404, and support services related to ML model performance monitoring specific to authorized ML models and target AIMLE clients (e.g., the AIMLE client 1402). In this way, steps 1408 through 1420 support ML model performance monitoring and in some cases, potential degradation detection. In some examples, one or more AIMLE services (at the AIMLE server 1404 or the AIMLE client 1402) using a given ML model may be ongoing. In addition, the AIMLE server 1404 and the VAL server 1406 may receive an access token from an authorization server as described in FIG. 2. The access token may include some or all of the information presented in Table 26. The access token may authorize the VAL server 1406 to communicate with the AIMLE server 1404, and the AIMLE server 1404 to communicate with the AIMLE clients 1402.

At 1408, the VAL server 1406 sends an ML model performance monitoring request to the AIMLE server 1404. The ML model performance monitoring request may include a requestor identity, security credentials (e.g., client certificates and/or root certificate to validate the client certificate), and the access token. The ML model performance monitoring request may request the AIMLE server 1404 to assist the VAL server 1406 in monitoring ML model performance.

At 1410, the AIMLE server 1404 performs authentication and authorization checks based on the security credentials and the access token (e.g., authorization information). If the requestor is authorized (i.e., if the AIMLE server 1404 verifies the received security credentials including certificates, and if the verification is successful), then the VAL server 1406 may perform the requested service. For example, if authorized, the VAL server 1406 may perform ML model performance monitoring as requested.

At 1412, the AIMLE server 1404 may send an ML model performance monitoring response to the VAL server 1406. The ML model performance monitoring response may include a successful response if the VAL server 1406 is authorized. The successful response may include a subscription ID corresponding to an associated subscription and an expiration time indicating an expiration time of the subscription (e.g., to maintain the active subscription, a subscription update is required before the expiration time). Alternatively, the ML model performance monitoring response may include a failure response if the authentication of the VAL server 1406 failed for some reason, which may include a cause of the failure.

At 1414, the AIMLE server 1404 may identify AIMLE services which are utilizing the requested ML model. Such AIMLE services may include ML model training services or HFL services at the AIMLE client 1402 or the AIMLE server 1404. In some examples, identification of the AIMLE services may be performed by fetching ML model information from an ML repository using an ML model management procedure. The AIMLE server 1404 may include its own security credentials (e.g., certificates, authentication token, access token) as a baseline. Then, the AIMLE server 1404 may begin monitoring AIMLE service performance (e.g., accuracy, KPIs, or QoS metrics related to AIML operation). Monitoring AIMLE service performance may include receiving information from one or more AIMLE clients 1402 performing an operation based on the target ML model with an expected or experienced deviation of the required performance of that AIMLE service.

At 1416, the AIMLE server 1404 may detect an expected ML model degradation (e.g., model drift, data drift) based on the deviation of the performance of the AIMLE service, as indicated in step 1414.

At 1418, the AIMLE server 1404 may indicate and execute a trigger action based on the expected ML model degradation. The AIMLE server 1404 may include its own security credentials in the indication to ensure that AIMLE service requirements are met. Such a trigger action may be an adaptation of the AIMLE service (e.g., training of a new ML model for the AIMLE by the same or a different AIMLE client), re-training of the ML model by the same or a different AIMLE client, or termination of the AIMLE service and subsequent initiation of a new AIMLE service with a new ML model. In some examples, the trigger action may involve re-selecting an AIMLE client 1402 for the AIMLE service.

At 1420, the AIMLE server 1404 may send an ML model performance monitoring notification to the VAL server 1406 notifying the VAL server 1406 of the expected ML model degradation and if requested, the trigger adaptation of the AIMLE service. In some examples, the ML model performance monitoring notification may include a subscription ID corresponding to an active subscription, an ML model ID, an ML model degradation indication (e.g., indicating the degradation of the ML model), ML model degradation parameters (e.g., performance metrics which are expected to be degraded, such as an F1-score, recall, precision, accuracy), a cause for the degradation of the ML model, a trigger action (e.g., the adaptation of the AIMLE service, such as training of a new ML model for the AIMLE by the same or a different AIMLE client, the re-training of the ML model by the same or different AIMLE client, or the termination of the AIMLE service and initiation of a new AIMLE service with a new ML model), or any combination thereof.

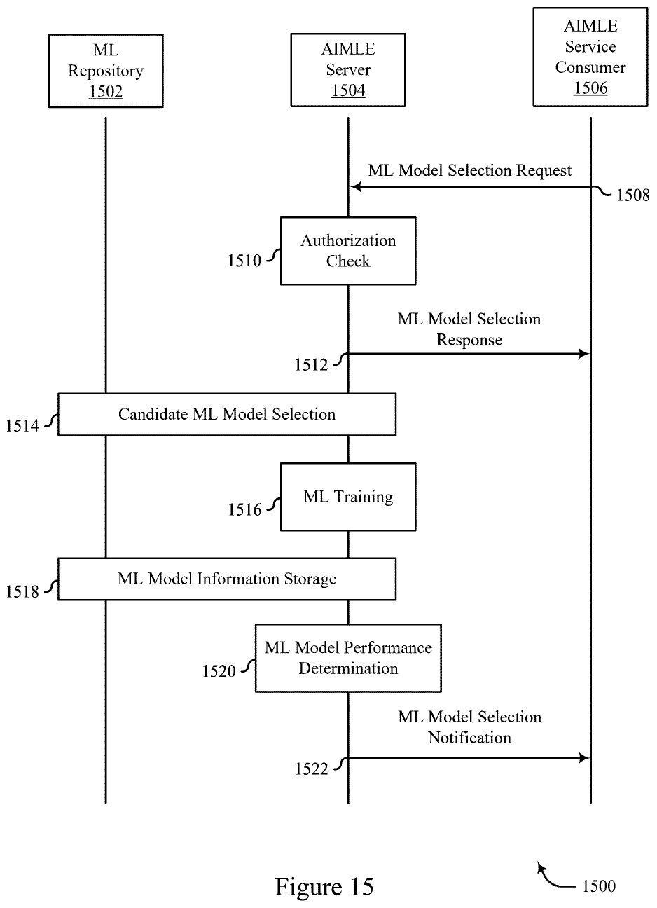

FIG. 15 illustrates an example of a process flow 1500 in accordance with aspects of the present disclosure. In some examples, the process flow 1500 may be performed by an ML repository 1502, an AIMLE server 1504, and an AIMLE service consumer 1506 (e.g., a VAL server).

Steps 1508 through 1522 may relate to ML model selection. Additionally, steps 1508 through 1522 support authentication and authentication verification of the AIMLE service consumer 1506 to request assistance with ML model selection from the AIMLE server 1504, where the AIMLE server 1504 may return only an authorized list of ML models with corresponding model performance to the AIMLE service consumer 1506. In some cases, many ML models exist for various ML applications, where some ML models may generate better results for a particular application and for a particular dataset than other ML models. Steps 1508 through 1522 may enable the AIMLE service consumer 1506 to request assistance from the AIMLE server 1504 with the selection of appropriate ML models for a given dataset and for some provided requirements. The AIMLE server 1504 may coordinate the selection of the candidate ML models and training of the candidate ML models with the given dataset. A list of ML models with their corresponding performance may be returned to the AIMLE service consumer 1506.

Prior to step 1508, the AIMLE service consumer 1506 may identify dataset and ML requirements and receive an access token from an authorization server as described in FIG. 2. The access token may include some or all of the information presented in Table 27. The access token may authorize the AIMLE service consumer 1506 to communicate with the AIMLE server 1504.

At 1508, the AIMLE service consumer 1506 sends an ML model selection request to the AIMLE server 1504. The ML model selection request may include a requestor identity, security credentials (e.g., client certificates and/or root certificate to validate the client certificate), and the access token. The ML model selection request may include a list of candidate ML models, dataset IDs, and requirements for training the candidate ML models. The AIMLE service consumer 1506 may either provide AIMLE client set IDs or AIMLE client selection criteria for selecting AIMLE clients to train the candidate ML models.

At 1510, the AIMLE server 1504 performs authentication and authorization checks based on the security credentials and the access token (e.g., authorization information). If the requestor is authorized (i.e., if the AIMLE server 1504 verifies the received security credentials including certificates, and if the verification is successful), then the AIMLE service consumer 1506 may perform the requested service. If authorized, the AIMLE server 1504 may assign an ID for the associated subscription.

At 1512, the AIMLE server 1504 may send an ML model selection response to the AIMLE service consumer 1506. The ML model selection response may include a status of the ML model selection operation and a subscription ID.

At 1514, the AIMLE server 1504 may determine if additional ML models may be candidates for a given type of ML application based on the ML model requirements indicated in the ML model selection request. The AIMLE server 1504 may select additional candidate ML models to train with the given dataset. In some cases, the AIMLE server 1504 may discover models from the ML repository 1502 to determine the list of candidate ML models.

At 1516, the AIMLE server 1504 may perform ML model training for each candidate ML model. The ML model training may be for split AI/ML operation, transfer learning, or FL. If the AIMLE client selection criteria were included in the ML model selection response, the AIMLE server 1504 may perform AIMLE client selection accordingly during the training of the candidate ML models. In some examples, training requirements may include a performance metric (e.g., indicating the performance of the ML model relative to ML model training, including mean absolute error, mean squared error, accuracy, precision, recall, and so forth), a performance target (e.g., indicating acceptable performance has been reached and training may be stopped), a minimum number of training rounds for the ML training, a minimum number of data samples for the ML training, or any combination thereof.

At 1518, the AIMLE server 1504 may perform ML model information storage for each trained ML model. For example, the AIMLE server 1504 may store the trained ML models in the ML repository 1502.

At 1520, the AIMLE server 1504 may aggregate and determine the performance of each ML model with the given dataset.

At 1522, the AIMLE server 1504 may send an ML model selection notification to the AIMLE service consumer 1506 notifying the AIMLE service consumer 1506 of the list of trained candidate ML models with corresponding model performance and other information. The AIMLE service consumer 1506 may then select the highest (e.g., best) performing ML models from the list provided in the ML model selection notification for use in a given application. In some examples, the ML model selection notification may include an associated subscription ID, an operational status (e.g., the status of the ML model selection operation, which may represent an estimated percent completion or associated with the notification settings), the trained ML models (e.g., the results of the ML model training), ML model information (e.g., ML model type and other information), ML model performance (e.g., a performance metric for training the ML model), an elapsed time for the ML model selection operation, a timestamp of the notification, or any combination thereof.

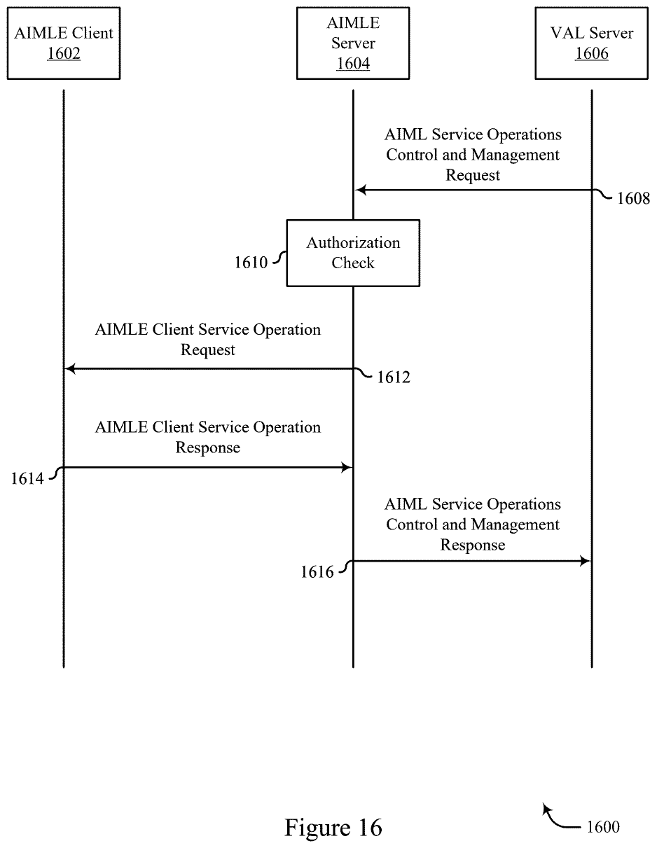

FIG. 16 illustrates an example of a process flow 1600 in accordance with aspects of the present disclosure. In some examples, the process flow 1600 may be performed by an AIMLE client 1602, an AIMLE server 1604, and a VAL server 1606 (e.g., an AIMLE service consumer).

Steps 1608 through 1616 may relate to AIMLE service operations control and management. Additionally, steps 1608 through 1616 support authentication and authentication verification of the VAL server 1606 to control an operation mode of an AIMLE service for a given AIML operation. The control and management of AIML services is useful for applications managing AIML services such as model training, inference, discovery, and so forth. Prior to step 1608, the VAL server 1606 and the AIMLE server 1604 may receive an access token from an authorization server as described in FIG. 2. The access token may include some or all of the information presented in Table 28. The access token may authorize the VAL server 1606 to communicate with the AIMLE server 1604, and the AIMLE server 1604 to communicate with the AIMLE client 1602.

At 1608, the VAL server 1606 sends an AIML service operations control and management request to the AIMLE server 1604. The AIML service operations control and management request may include a requestor identity, security credentials (e.g., client certificates and/or root certificate to validate the client certificate), and the access token.

At 1610, the AIMLE server 1604 performs authentication and authorization checks based on the security credentials and the access token (e.g., authorization information). If the requestor is authorized (i.e., if the AIMLE server 1604 verifies the received security credentials including certificates, and if the verification is successful), then the VAL server 1606 may perform the requested service.

At 1612, the AIMLE server 1604 may determine a required service operation model to manage the AIML service operation lifecycle based on an AIML service operation mode and AIML service operation information. For example, the AIMLE server 1604 may perform client discovery/selection by including its own security credentials (e.g., certificates, authorization token, or access token) and model training using defined procedures. Based on the AIML client ID, the AIMLE server 1604 sends the AIMLE client service operation request to the AIMLE client 1602. The AIML service operation mode may include start and stop operations, where a start operation indicates the initiation of the AIML service, and a stop operation indicates termination of the AIML service.

At 1614, the AIMLE client 1602 may perform authentication and authorization checks based on the security credentials and the access token (e.g., authorization information). If the requestor is authorized (i.e., if the AIMLE client 1602 verifies the received security credentials including certificates, and if the verification is successful), then the AIMLE server 1604 may perform the requested service. The AIMLE client 1602 receiving the AIMLE service operation request, including an AIML service operation mode, may perform the service operation mode for the AIML service operation. The AIMLE client 1602 may configure and monitor the AIML service operation as per the AIML service operation mode configuration.

Based on the AIML service operation mode status reporting configuration (periodic or event-triggered), the AIMLE client 1602 may report the service operation mode status to the AIMLE server 1604 by sending an AIMLE client service operation response. The AIMLE client service operation response may indicate the success or failure of the AIMLE client service operation. Additionally, the AIMLE client service operation response may include a VAL service ID (e.g., an ID for the VAL server 1606 associated with the requestor), an AIML service operation ID, an AIML service operation mode status (e.g., indicating a current state of the AIMLE service operation, possible start and stop values, etc.), or any combination thereof.

At 1616, the AIMLE server 1604 may send an AIML service operations control and management response to the VAL server 1606. The AIML service operations control and management response includes an AIML service operation ID and a reporting status of the AIML service operation. For example, the AIML service operations control and management response may indicate the success or failure of the AIMLE client service operation. Additionally, the AIMLE client service operation response may include a VAL service ID (e.g., an ID for the VAL server 1606 associated with the requestor), an AIML service operation ID, an AIML service operation mode status (e.g., indicating a current state of the AIMLE service operation, possible start and stop values, etc.), or any combination thereof.

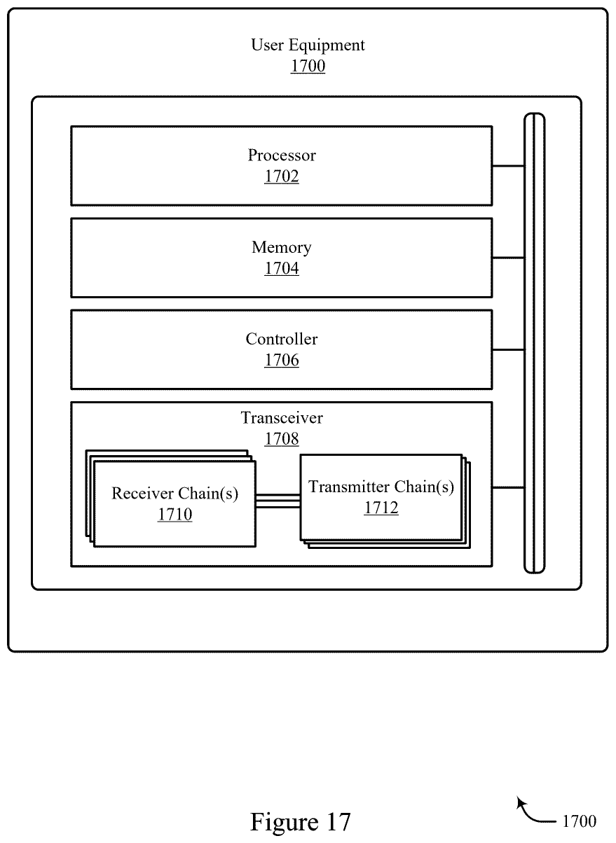

FIG. 17 illustrates an example of a UE 1700 in accordance with aspects of the present disclosure. In some examples, the UE 1700 may be an example of a UE as described with reference to FIG. 1. Further, the UE 1700 may be an example of a service device, an AIMLE client or an VAL client as described with reference to FIGS. 2 through 16. The UE 1700 may include a processor 1702, a memory 1704, a controller 1706, and a transceiver 1708. The processor 1702, the memory 1704, the controller 1706, or the transceiver 1708, or various combinations thereof or various components thereof may be examples of means for performing various aspects of the present disclosure as described herein. These components may be coupled (e.g., operatively, communicatively, functionally, electronically, electrically) via one or more interfaces.

The processor 1702, the memory 1704, the controller 1706, or the transceiver 1708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1702 may include an intelligent hardware device (e.g., a general-purpose processor, a DSP, a CPU, an ASIC, an FPGA, or any combination thereof). In some implementations, the processor 1702 may be configured to operate the memory 1704. In some other implementations, the memory 1704 may be integrated into the processor 1702. The processor 1702 may be configured to execute computer-readable instructions stored in the memory 1704 to cause the UE 1700 to perform various functions of the present disclosure.

The memory 1704 may include volatile or non-volatile memory. The memory 1704 may store computer-readable, computer-executable code including instructions when executed by the processor 1702 cause the UE 1700 to perform various functions described herein. The code may be stored in a non-transitory computer-readable medium such as the memory 1704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1702 and the memory 1704 coupled with the processor 1702 may be configured to cause the UE 1700 to perform one or more of the functions described herein (e.g., executing, by the processor 1702, instructions stored in the memory 1704). For example, the processor 1702 may support wireless communication at the UE 1700 in accordance with examples as disclosed herein. The UE 1700 may be configured to or operable to support a means for transmitting a first message requesting an access token including a scope related to an AIMLE client device management service and receiving, responsive to the first message, a second message including the access token, the access token including one or more claims associated with the scope that identify one or more permissions for the AIMLE client device management service.

Additionally, or alternatively, the UE 1700 may support at least one memory (e.g., the memory 1704) and at least one processor (e.g., the processor 1702) coupled with the at least one memory and configured to cause the UE to transmit a first message requesting an access token including a scope related to an AIMLE client device management service and receive, responsive to the first message, a second message including the access token, the access token including one or more claims associated with the scope that identify one or more permissions for the AIMLE client device management service.

Additionally, the UE 1700 may be configured to support any one or combination of the at least one processor configured to cause the UE 1700 to transmit a third message requesting to register the service device with a server, the third message including the access token and receive, responsive to the third message and based on the access token, a fourth message including an indication of whether the service device is permitted to be registered with the server.

Additionally, the UE 1700 may be configured to support any one or combination of the at least one processor configured to cause the UE 1700 to transmit a fifth message to discover client devices that are available to participate in AIML services, the fifth message including the access token and receive, responsive to the fifth message and based on the access token, a sixth message including an indication of whether one or more client devices are available to participate in AIML services.

Additionally, the UE 1700 may be configured to support any one or combination of the at least one processor configured to cause the UE 1700 to transmit a seventh message to select client devices that are available to participate in AIML services, the seventh message including the access token and receive, responsive to the seventh message and based on the access token, an eighth message verifying selection of one or more client devices to participate in AIML services.

Additionally, the UE 1700 may be configured to support any one or combination of the at least one processor configured to cause the UE 1700 to transmit a ninth message requesting a client device to verify participation in AIML services, the ninth message including the access token and receive, responsive to the ninth message and based on the access token, a tenth message including an indication of whether the client device is a participant in AIML services.

Additionally, the UE 1700 may be configured to support any one or combination of the at least one processor configured to cause the UE 1700 to transmit an eleventh message requesting to subscribe to monitoring one or more client devices, where the eleventh message includes the access token and receive, in response to the eleventh message and based on the access token, a twelve message including an indication of whether the subscription to monitoring the one or more client devices is successful.

The controller 1706 may manage input and output signals for the UE 1700. The controller 1706 may also manage peripherals not integrated into the UE 1700. In some implementations, the controller 1706 may utilize an operating system such as iOS®, ANDROID®, WINDOWS®, or other operating systems. In some implementations, the controller 1706 may be implemented as part of the processor 1702.

In some implementations, the UE 1700 may include at least one transceiver 1708. In some other implementations, the UE 1700 may have more than one transceiver 1708. The transceiver 1708 may represent a wireless transceiver. The transceiver 1708 may include one or more receiver chains 1710, one or more transmitter chains 1712, or a combination thereof.

A receiver chain 1710 may be configured to receive signals (e.g., control information, data, packets) over a wireless medium. For example, the receiver chain 1710 may include one or more antennas to receive a signal over the air or wireless medium. The receiver chain 1710 may include at least one amplifier (e.g., a low-noise amplifier (LNA)) configured to amplify the received signal. The receiver chain 1710 may include at least one demodulator configured to demodulate the receive signal and obtain the transmitted data by reversing the modulation technique applied during transmission of the signal. The receiver chain 1710 may include at least one decoder for decoding the demodulated signal to receive the transmitted data.

A transmitter chain 1712 may be configured to generate and transmit signals (e.g., control information, data, packets). The transmitter chain 1712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1712 may also include at least one power amplifier configured to amplify the modulated signal to an appropriate power level suitable for transmission over the wireless medium. The transmitter chain 1712 may also include one or more antennas for transmitting the amplified signal into the air or wireless medium.

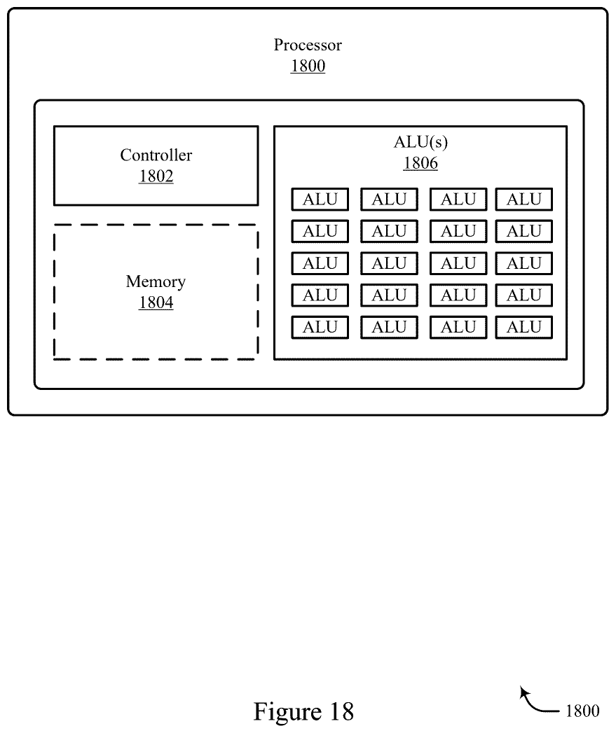

FIG. 18 illustrates an example of a processor 1800 in accordance with aspects of the present disclosure. The processor 1800 may be an example of a processor configured to perform various operations in accordance with examples as described herein. The processor 1800 may include a controller 1802 configured to perform various operations in accordance with examples as described herein. The processor 1800 may optionally include at least one memory 1804, which may be, for example, an L1/L2/L3 cache. Additionally, or alternatively, the processor 1800 may optionally include one or more arithmetic-logic units (ALUs) 1806. One or more of these components may be in electronic communication or otherwise coupled (e.g., operatively, communicatively, functionally, electronically, electrically) via one or more interfaces (e.g., buses).

The processor 1800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1802 may be configured to manage and coordinate various operations (e.g., signaling, receiving, obtaining, retrieving, transmitting, outputting, forwarding, storing, determining, identifying, accessing, writing, reading) of the processor 1800 to cause the processor 1800 to support various operations in accordance with examples as described herein. For example, the controller 1802 may operate as a control unit of the processor 1800, generating control signals that manage the operation of various components of the processor 1800. These control signals include enabling or disabling functional units, selecting data paths, initiating memory access, and coordinating timing of operations.

The controller 1802 may be configured to fetch (e.g., obtain, retrieve, receive) instructions from the memory 1804 and determine subsequent instruction(s) to be executed to cause the processor 1800 to support various operations in accordance with examples as described herein. The controller 1802 may be configured to track memory addresses of instructions associated with the memory 1804. The controller 1802 may be configured to decode instructions to determine the operation to be performed and the operands involved. For example, the controller 1802 may be configured to interpret the instruction and determine control signals to be output to other components of the processor 1800 to cause the processor 1800 to support various operations in accordance with examples as described herein. Additionally, or alternatively, the controller 1802 may be configured to manage flow of data within the processor 1800. The controller 1802 may be configured to control transfer of data between registers, ALUs 1806, and other functional units of the processor 1800.

The memory 1804 may include one or more caches (e.g., memory local to or included in the processor 1800 or other memory, such as RAM, ROM, DRAM, SDRAM, SRAM, MRAM, flash memory, etc. In some implementations, the memory 1804 may reside within or on a processor chipset (e.g., local to the processor 1800). In some other implementations, the memory 1804 may reside external to the processor chipset (e.g., remote to the processor 1800).

The memory 1804 may store computer-readable, computer-executable code including instructions that, when executed by the processor 1800, cause the processor 1800 to perform various functions described herein. The code may be stored in a non-transitory computer-readable medium such as system memory or another type of memory. The controller 1802 and/or the processor 1800 may be configured to execute computer-readable instructions stored in the memory 1804 to cause the processor 1800 to perform various functions. For example, the processor 1800 and/or the controller 1802 may be coupled with or to the memory 1804, the processor 1800, and the controller 1802, and may be configured to perform various functions described herein. In some examples, the processor 1800 may include multiple processors and the memory 1804 may include multiple memories. One or more of the multiple processors may be coupled with one or more of the multiple memories, which may, individually or collectively, be configured to perform various functions herein.

The one or more ALUs 1806 may be configured to support various operations in accordance with examples as described herein. In some implementations, the one or more ALUs 1806 may reside within or on a processor chipset (e.g., the processor 1800). In some other implementations, the one or more ALUs 1806 may reside external to the processor chipset (e.g., the processor 1800). One or more ALUs 1806 may perform one or more computations such as addition, subtraction, multiplication, and division on data. For example, one or more ALUs 1806 may receive input operands and an operation code, which determines an operation to be executed. One or more ALUs 1806 may be configured with a variety of logical and arithmetic circuits, including adders, subtractors, shifters, and logic gates, to process and manipulate the data according to the operation. Additionally, or alternatively, the one or more ALUs 1806 may support logical operations such as AND, OR, exclusive-OR (XOR), not-OR (NOR), and not-AND (NAND), enabling the one or more ALUs 1806 to handle conditional operations, comparisons, and bitwise operations.

The processor 1800 may support wireless communication in accordance with examples as disclosed herein. The processor 1800 may be configured to or operable to support at least one controller (e.g., the controller 1802) coupled with at least one memory (e.g., the memory 1804) and configured to cause the processor to transmit a first message requesting an access token including a scope related to an AIMLE client device management service and receive, responsive to the first message, a second message including the access token, the access token including one or more claims associated with the scope that identify one or more permissions for the AIMLE client device management service.

Additionally, the processor 1800 may be configured to or operable to support any one or combination of transmitting a third message requesting to register the service device with a server, the third message including the access token and receiving, responsive to the third message and based on the access token, a fourth message including an indication of whether the service device is permitted to be registered with the server.

Additionally, the processor 1800 may be configured to or operable to support any one or combination of transmitting a fifth message to discover client devices that are available to participate in AIML services, the fifth message including the access token and receiving, responsive to the fifth message and based on the access token, a sixth message including an indication of whether one or more client devices are available to participate in AIML services.

Additionally, the processor 1800 may be configured to or operable to support any one or combination of transmitting a seventh message to select client devices that are available to participate in AIML services, the seventh message including the access token and receiving, responsive to the seventh message and based on the access token, an eighth message verifying selection of one or more client devices to participate in AIML services.

Additionally, the processor 1800 may be configured to or operable to support any one or combination of transmitting a ninth message requesting a client device to verify participation in AIML services, the ninth message including the access token and receiving, responsive to the ninth message and based on the access token, a tenth message including an indication of whether the client device is a participant in AIML services.

Additionally, the processor 1800 may be configured to or operable to support any one or combination of transmitting an eleventh message requesting to subscribe to monitoring one or more client devices, where the eleventh message includes the access token and receiving, in response to the eleventh message and based on the access token, a twelve message including an indication of whether the subscription to monitoring the one or more client devices is successful.

Moreover, the processor 1800 may be configured to or operable to support at least one controller (e.g., the controller 1802) coupled with at least one memory (e.g., the memory 1804) and configured to cause the processor to receive a first message requesting an access token including a scope related to an AIMLE client device management service, generate the access token including one or more claims associated with the scope that identify one or more permissions for the AIMLE client device management service, and transmit, responsive to the first message, a second message including the access token.

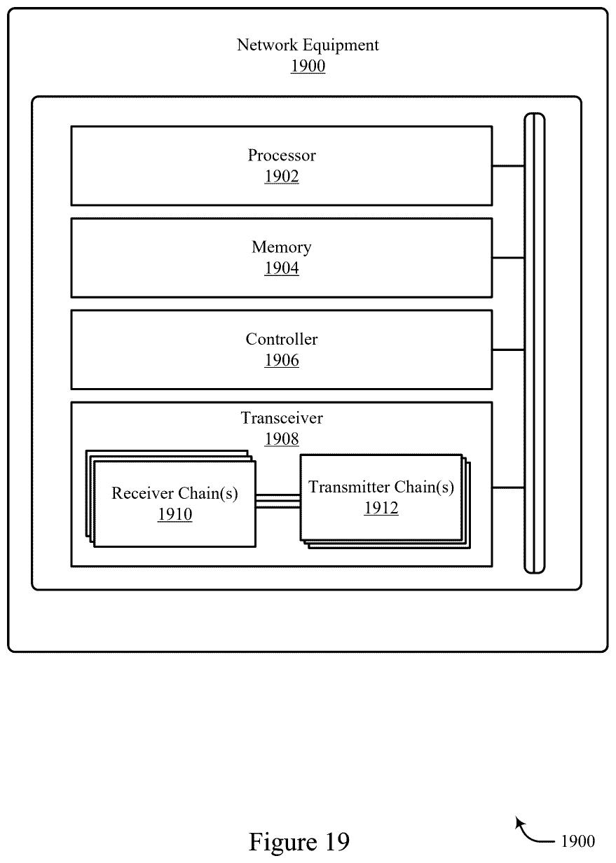

FIG. 19 illustrates an example of an NE 1900 in accordance with aspects of the present disclosure. The NE 1900 may be an example of the NE as described with reference to FIG. 1. Further, the NE 1900 may be an example of the authorization device, the service device, the AIMLE server, or VAL server as described with reference to FIGS. 1 through 16. The NE 1900 may include a processor 1902, a memory 1904, a controller 1906, and a transceiver 1908. The processor 1902, the memory 1904, the controller 1906, or the transceiver 1908, or various combinations thereof or various components thereof may be examples of means for performing various aspects of the present disclosure as described herein. These components may be coupled (e.g., operatively, communicatively, functionally, electronically, electrically) via one or more interfaces.

The processor 1902, the memory 1904, the controller 1906, or the transceiver 1908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1902 may include an intelligent hardware device (e.g., a general-purpose processor, a DSP, a CPU, an ASIC, an FPGA, or any combination thereof). In some implementations, the processor 1902 may be configured to operate the memory 1904. In some other implementations, the memory 1904 may be integrated into the processor 1902. The processor 1902 may be configured to execute computer-readable instructions stored in the memory 1904 to cause the NE 1900 to perform various functions of the present disclosure.

The memory 1904 may include volatile or non-volatile memory. The memory 1904 may store computer-readable, computer-executable code including instructions when executed by the processor 1902 cause the NE 1900 to perform various functions described herein. The code may be stored in a non-transitory computer-readable medium such as the memory 1904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1902 and the memory 1904 coupled with the processor 1902 may be configured to cause the NE 1900 to perform one or more of the functions described herein (e.g., executing, by the processor 1902, instructions stored in the memory 1904). For example, the processor 1902 may support wireless communication at the NE 1900 in accordance with examples as disclosed herein. The NE 1900 may be configured to or operable to support a means for transmitting a first message requesting an access token including a scope related to an AIMLE client device management service and receiving, responsive to the first message, a second message including the access token, the access token including one or more claims associated with the scope that identify one or more permissions for the AIMLE client device management service.

Additionally, or alternatively, the NE 1900 may support at least one memory (e.g., the memory 1904) and at least one processor (e.g., the processor 1902) coupled with the at least one memory and configured to cause the NE to transmit a first message requesting an access token including a scope related to an AIMLE client device management service and receive, responsive to the first message, a second message including the access token, the access token including one or more claims associated with the scope that identify one or more permissions for the AIMLE client device management service.

Additionally, the NE 1900 may be configured to support any one or combination of the at least one processor configured to cause the NE 1900 to transmit a third message requesting to register the service device with a server, the third message including the access token and receive, responsive to the third message and based on the access token, a fourth message including an indication of whether the service device is permitted to be registered with the server.

Additionally, the NE 1900 may be configured to support any one or combination of the at least one processor configured to cause the NE 1900 to transmit a fifth message to discover client devices that are available to participate in AIML services, the fifth message including the access token and receive, responsive to the fifth message and based on the access token, a sixth message including an indication of whether one or more client devices are available to participate in AIML services.

Additionally, the NE 1900 may be configured to support any one or combination of the at least one processor configured to cause the NE 1900 to transmit a seventh message to select client devices that are available to participate in AIML services, the seventh message including the access token and receive, responsive to the seventh message and based on the access token, an eighth message verifying selection of one or more client devices to participate in AIML services.

Additionally, the NE 1900 may be configured to support any one or combination of the at least one processor configured to cause the NE 1900 to transmit a ninth message requesting a client device to verify participation in AIML services, the ninth message including the access token and receive, responsive to the ninth message and based on the access token, a tenth message including an indication of whether the client device is a participant in AIML services.

Additionally, the NE 1900 may be configured to support any one or combination of the at least one processor configured to cause the NE 1900 to transmit an eleventh message requesting to subscribe to monitoring one or more client devices, where the eleventh message includes the access token and receive, in response to the eleventh message and based on the access token, a twelve message including an indication of whether the subscription to monitoring the one or more client devices is successful.

Additionally, the NE 1900 may be configured to or operable to support a means for receiving a first message requesting an access token including a scope related to an AIMLE client device management service, generating the access token including one or more claims associated with the scope that identify one or more permissions for the AIMLE client device management service, and transmitting, responsive to the first message, a second message including the access token.

Additionally, or alternatively, the NE 1900 may support at least one memory (e.g., the memory 1904) and at least one processor (e.g., the processor 1902) coupled with the at least one memory and configured to cause the NE to receive a first message requesting an access token including a scope related to an AIMLE client device management service, generate the access token including one or more claims associated with the scope that identify one or more permissions for the AIMLE client device management service, and transmit, responsive to the first message, a second message including the access token.

The controller 1906 may manage input and output signals for the NE 1900. The controller 1906 may also manage peripherals not integrated into the NE 1900. In some implementations, the controller 1906 may utilize an operating system such as iOS®, ANDROID®, WINDOWS®, or other operating systems. In some implementations, the controller 1906 may be implemented as part of the processor 1902.

In some implementations, the NE 1900 may include at least one transceiver 1908. In some other implementations, the NE 1900 may have more than one transceiver 1908. The transceiver 1908 may represent a wireless transceiver. The transceiver 1908 may include one or more receiver chains 1910, one or more transmitter chains 1912, or a combination thereof.

A receiver chain 1910 may be configured to receive signals (e.g., control information, data, packets) over a wireless medium. For example, the receiver chain 1910 may include one or more antennas to receive a signal over the air or wireless medium. The receiver chain 1910 may include at least one amplifier (e.g., a low-noise amplifier (LNA)) configured to amplify the received signal. The receiver chain 1910 may include at least one demodulator configured to demodulate the receive signal and obtain the transmitted data by reversing the modulation technique applied during transmission of the signal. The receiver chain 1910 may include at least one decoder for decoding the demodulated signal to receive the transmitted data.

A transmitter chain 1912 may be configured to generate and transmit signals (e.g., control information, data, packets). The transmitter chain 1912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1912 may also include at least one power amplifier configured to amplify the modulated signal to an appropriate power level suitable for transmission over the wireless medium. The transmitter chain 1912 may also include one or more antennas for transmitting the amplified signal into the air or wireless medium.

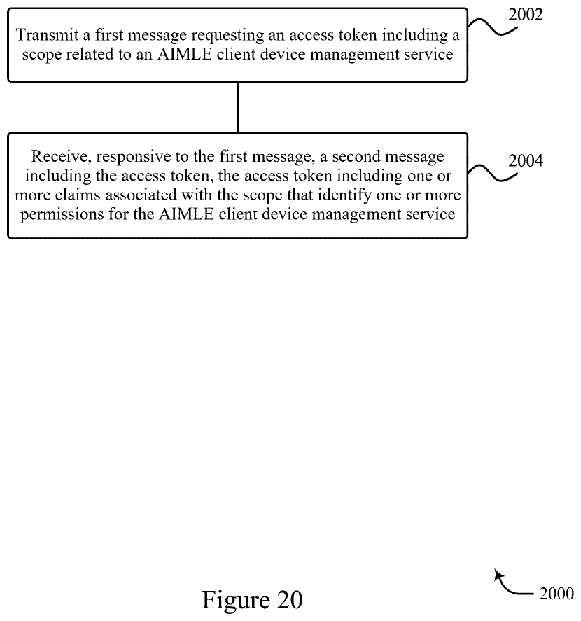

FIG. 20 illustrates a flowchart of a method 2000 in accordance with aspects of the present disclosure. The operations of the method may be implemented by a service device as described herein. In some implementations, the service device may execute a set of instructions to control the function elements of the service device to perform the described functions. It should be noted that the method described herein describes a possible implementation, and that the operations and the steps may be rearranged or otherwise modified and that other implementations are possible.

At 2002, the method may include transmitting a first message requesting an access token including a scope related to an AIMLE client device management service. The operations of 2002 may be performed in accordance with examples as described herein. In some implementations, aspects of the operations of 2002 may be performed by the UE 1700 or the NE 1900 as described with reference to FIGS. 17 and 19.

At 2004, the method may include receiving, responsive to the first message, a second message including the access token, the access token including one or more claims associated with the scope that identify one or more permissions for the AIMLE client device management service. The operations of 2004 may be performed in accordance with examples as described herein. In some implementations, aspects of the operations of 2004 may be performed by the UE 1700 or the NE 1900 as described with reference to FIGS. 17 and 1900.

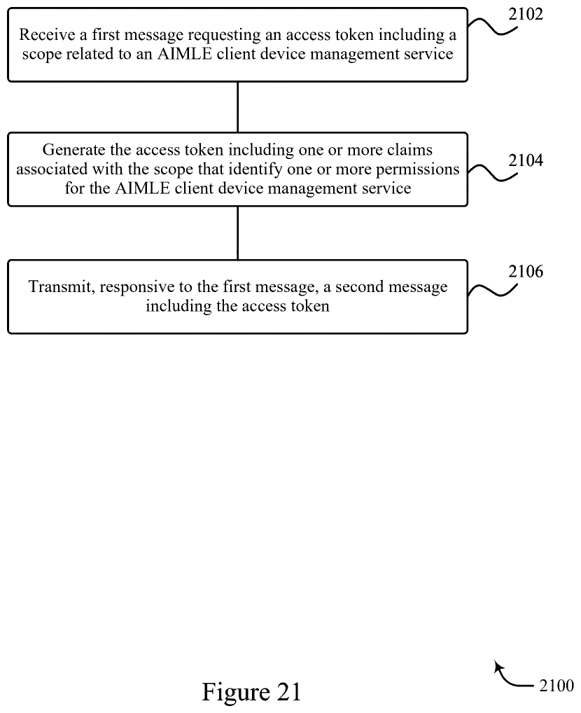

FIG. 21 illustrates a flowchart of a method 2100 in accordance with aspects of the present disclosure. The operations of the method may be implemented by an authorization device as described herein. In some implementations, the authorization device may execute a set of instructions to control the function elements of the authorization device to perform the described functions. It should be noted that the method described herein describes a possible implementation, and that the operations and the steps may be rearranged or otherwise modified and that other implementations are possible.

At 2102, the method may include receiving a first message requesting an access token including a scope related to an AIMLE client device management service. The operations of 2102 may be performed in accordance with examples as described herein. In some implementations, aspects of the operations of 2102 may be performed by the NE 1900 as described with reference to FIG. 19.

At 2104, the method may include generating the access token including one or more claims associated with the scope that identify one or more permissions for the AIMLE client device management service. The operations of 2104 may be performed in accordance with examples as described herein. In some implementations, aspects of the operations of 2104 may be performed by the NE 1900 as described with reference to FIG. 19.

At 2106, the method may include transmitting, responsive to the first message, a second message including the access token. The operations of 2106 may be performed in accordance with examples as described herein. In some implementations, aspects of the operations of 2106 may be performed by the NE 1900 as described with reference to FIG. 19.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A service device for wireless communication, comprising:
at least one memory; and
at least one processor coupled with the at least one memory and operable to cause the service device to:
transmit a first message requesting an access token comprising a scope related to an artificial intelligence machine learning enablement (AIMLE) client device management service; and
receive, responsive to the first message, a second message comprising the access token, the access token comprising one or more claims associated with the scope that identify one or more permissions for the AIMLE client device management service.

2. The service device of claim 1, wherein, responsive to the AIMLE client device management service comprising a client registration service, the first message comprises expected AIMLE client profiles, expected vertical application layer (VAL) services and expected corresponding permission levels, expected AIML services, expected AIML operations, expected client location, expected AIMLE client capabilities, expected ML models, a resource owner identifier (ID), an audience ID, or any combination thereof; and
the one or more claims comprise allowed AIMLE client profiles, allowed VAL services and allowed corresponding permission levels, allowed AIML services, allowed AIML operations, allowed client location, allowed AIMLE client capabilities, allowed ML models, the resource owner ID, an issuer ID, the audience ID, an expiration time, or any combination thereof.

3. The service device of claim 2, wherein the at least one processor is further operable to cause the service device to:
transmit a third message requesting to register the service device with a server, the third message comprising the access token; and
receive, responsive to the third message and based on the access token, a fourth message comprising an indication of whether the service device is permitted to be registered with the server.

4. The service device of claim 1, wherein, responsive to the AIMLE client device management service comprising an AIML client discovery service, the first message comprises an expected maximum quantity of AIMLE clients, expected AIMLE client discovery criteria, expected vertical application layer (VAL) services, expected ML model types, expected AIML services, expected AIML operations, expected dataset requirements, expected client location, expected AIMLE client capabilities, a resource owner identifier (ID), an audience ID, or any combination thereof; and
the one or more claims comprise an allowed maximum quantity of AIMLE clients, allowed AIMLE client discovery criteria, allowed VAL services, allowed ML model types, allowed AIML services, allowed AIML operations, allowed dataset requirements, allowed client location, allowed client capabilities, the resource owner ID, an issuer ID, the audience ID, an expiration time, or any combination thereof.

5. The service device of claim 4, wherein the at least one processor is further operable to cause the service device to:
transmit a fifth message to discover client devices that are available to participate in AIML services, the fifth message comprising the access token; and
receive, responsive to the fifth message and based on the access token, a sixth message comprising an indication of whether one or more client devices are available to participate in AIML services.

6. The service device of claim 1, wherein, responsive to the AIMLE client device management service comprising an AIML client selection service, the first message comprises an expected maximum number of AIMLE clients, expected vertical application layer (VAL) services, expected AIMLE client identifiers (IDs), expected AIMLE client selection criteria, expected ML model types, expected AIML services, expected AIML operations, expected dataset requirements, expected client location, expected AIMLE client capabilities, expected AIMLE client set IDs, a resource owner ID, an audience ID, or any combination thereof; and
the one or more claims comprise an allowed maximum number of AIMLE clients, allowed VAL services, allowed AIMLE client IDs, allowed AIMLE client selection criteria, allowed ML model types, allowed AIML services, allowed AIML operations, allowed dataset requirements, allowed client location, allowed AIMLE client capabilities, allowed AIMLE client set IDs, the resource owner ID, an issuer ID, the audience ID, an expiration time, or any combination thereof.

7. The service device of claim 6, wherein the at least one processor is further operable to cause the service device to:
transmit a seventh message to select client devices that are available to participate in AIML services, the seventh message comprising the access token; and
receive, responsive to the seventh message and based on the access token, an eighth message verifying selection of one or more client devices to participate in AIML services.

8. The service device of claim 1, wherein, responsive to the AIMLE client device management service comprising a client participation service, the first message comprises expected vertical application layer (VAL) services, expected AIMLE client set identifier (IDs), expected operation, target ML models, expected AIML services, expected AIML operations, expected AIMLE client selection criteria, expected dataset requirements, a resource owner ID, an audience ID, or any combination thereof; and
the one or more claims comprise allowed VAL services, allowed AIMLE client set IDs, allowed AIML server IDs, allowed operation, allowed ML models, allowed AIML services, allowed AIML operations, allowed AIMLE client selection criteria, allowed dataset requirements, the resource owner ID, an issuer ID, the audience ID, an expiration time, or any combination thereof.

9. The service device of claim 8, wherein the at least one processor is further operable to cause the service device to:
transmit a ninth message requesting a client device to verify participation in AIML services, the ninth message comprising the access token; and
receive, responsive to the ninth message and based on the access token, a tenth message comprising an indication of whether the client device is a participant in AIML services.

10. The service device of claim 1, wherein, responsive to the AIMLE client device management service comprising a client selection subscription service, the first message comprises expected vertical application layer (VAL) services, expected AIMLE client selection criteria, expected quantity of AIMLE clients for selection, target notification endpoint for selected AIMLE clients, a resource owner identifier (ID), an audience ID, or any combination thereof; and
the one or more claims comprise allowed VAL services, allowed AIMLE client selection criteria, allowed quantity of AIMLE clients for selection, allowed notification endpoint for selected AIMLE clients, an issuer ID, the resource owner ID, the audience ID, an expiration time, or any combination thereof.

11. The service device of claim 10, wherein the at least one processor is further operable to cause the service device to:
transmit an eleventh message requesting to subscribe to monitoring one or more client devices, wherein the eleventh message comprises the access token; and
receive, in response to the eleventh message and based on the access token, a twelve message comprising an indication of whether the subscription to monitoring the one or more client devices is successful.

12. The service device of claim 1, wherein the service device comprises one of an AIMLE client, an AIMLE server, a vertical application layer (VAL) client, or a VAL server.

13. An authorization device for wireless communication, comprising:
at least one memory; and
at least one processor coupled with the at least one memory and operable to cause the authorization device to:
receive a first message requesting an access token comprising a scope related to an artificial intelligence machine learning enablement (AIMLE) client device management service;
generate the access token comprising one or more claims associated with the scope that identify one or more permissions for the AIMLE client device management service; and
transmit, responsive to the first message, a second message comprising the access token.

14. The authorization device of claim 13, wherein, responsive to the AIMLE client device management service comprising a client registration service, the first message comprises expected AIMLE client profiles, expected vertical application layer (VAL) services and expected corresponding permission levels, expected AIML services, expected AIML operations, expected client location, expected AIMLE client capabilities, expected ML models, a resource owner identifier (ID), an audience ID, or any combination thereof; and
the one or more claims comprise allowed AIMLE client profiles, allowed VAL services and allowed corresponding permission levels, allowed AIML services, allowed AIML operations, allowed client location, allowed AIMLE client capabilities, allowed ML models, the resource owner ID, an issuer ID, the audience ID, an expiration time, or any combination thereof.

15. The authorization device of claim 13, wherein, responsive to the AIMLE client device management service comprising an AIML client discovery service, the first message comprises an expected maximum quantity of AIMLE clients, expected AIMLE client discovery criteria, expected vertical application layer (VAL) services, expected ML model types, expected AIML services, expected AIML operations, expected dataset requirements, expected client location, expected AIMLE client capabilities, a resource owner identifier (ID), an audience ID, or any combination thereof; and
the one or more claims comprise an allowed maximum quantity of AIMLE clients, allowed AIMLE client discovery criteria, allowed VAL services, allowed ML model types, allowed AIML services, allowed AIML operations, allowed dataset requirements, allowed client location, allowed client capabilities, the resource owner ID, an issuer ID, the audience ID, an expiration time, or any combination thereof.

16. The authorization device of claim 13, wherein, responsive to the AIMLE client device management service comprising an AIML client selection service, the first message comprises an expected maximum number of AIMLE clients, expected vertical application layer (VAL) services, expected AIMLE client identifiers (IDs), expected AIMLE client selection criteria, expected ML model types, expected AIML services, expected AIML operations, expected dataset requirements, expected client location, expected AIMLE client capabilities, expected AIMLE client set IDs, a resource owner ID, an audience ID, or any combination thereof; and
the one or more claims comprise an allowed maximum number of AIMLE clients, allowed VAL services, allowed AIMLE client IDs, allowed AIMLE client selection criteria, allowed ML model types, allowed AIML services, allowed AIML operations, allowed dataset requirements, allowed client location, allowed AIMLE client capabilities, allowed AIMLE client set IDs, the resource owner ID, an issuer ID, the audience ID, an expiration time, or any combination thereof.

17. The authorization device of claim 13, wherein, responsive to the AIMLE client device management service comprising a client participation service, the first message comprises expected vertical application layer (VAL) services, expected AIMLE client set identifier (IDs), expected operation, target ML models, expected AIML services, expected AIML operations, expected AIMLE client selection criteria, expected dataset requirements, a resource owner ID, an audience ID, or any combination thereof; and
the one or more claims comprise allowed VAL services, allowed AIMLE client set IDs, allowed AIML server IDs, allowed operation, allowed ML models, allowed AIML services, allowed AIML operations, allowed AIMLE client selection criteria, allowed dataset requirements, the resource owner ID, an issuer ID, the audience ID, an expiration time, or any combination thereof.

18. The authorization device of claim 13, wherein, responsive to the AIMLE client device management service comprising a client selection subscription service, the first message comprises expected vertical application layer (VAL) services, expected AIMLE client selection criteria, expected quantity of AIMLE clients for selection, target notification endpoint for selected AIMLE clients, a resource owner identifier (ID), an audience ID, or any combination thereof; and
the one or more claims comprise allowed VAL services, allowed AIMLE client selection criteria, allowed quantity of AIMLE clients for selection, allowed notification endpoint for selected AIMLE clients, an issuer ID, the resource owner ID, the audience ID, an expiration time, or any combination thereof.

19. A method performed by a service device, the method comprising:
transmitting a first message requesting an access token comprising a scope related to an artificial intelligence machine learning enablement (AIMLE) client device management service; and
receiving, responsive to the first message, a second message comprising the access token, the access token comprising one or more claims associated with the scope that identify one or more permissions for the AIMLE client device management service.

20. A method performed by an authorization device, the method comprising:
receiving a first message requesting an access token comprising a scope related to an artificial intelligence machine learning enablement (AIMLE) client device management service;
generating the access token comprising one or more claims associated with the scope that identify one or more permissions for the AIMLE client device management service; and
transmitting, responsive to the first message, a second message comprising the access token.
